(19) United States
(12) Patent Application Publication
(10) Pub. No.: US 2004/0267747 A1
(43) Pub. Date: Dec. 30, 2004

(54) Transaction processing system supporting concurrent accesses to hierarchical data by transactions

(75) Inventors: Eun Hye Choi, Minoh-shi (JP); Tatsunori Kanai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/765,145

(22) Filed: Jan. 28, 2004

(30) Foreign Application Priority Data
Jan. 31, 2003 (JP) 2003-025164

(51) Int. Cl. G06F 17/30

(52) U.S. Cl. 707/8

(57) ABSTRACT

In a transaction processing system for processing a plurality of transactions in parallel with respect to hierarchical data, a copy of the hierarchical data is produced at a time of starting each transaction, and whether a collision between a reading or writing access to be made by a first transaction with respect to a copy and a writing or reading access made by the second transaction with respect to a copy will occur or not is judged and a processing for avoiding the collision is carried out when it is judged that the collision will occur. When the first transaction is to be finished normally, a writing access made by the first transaction with respect to a copy of the hierarchical data for the first transaction is reflected on the hierarchical data, as well as on a copy for the second transaction if the second transaction is not finished yet.

### BACKGROUND OF THE INVENTION

1. Field of the Invention

The present invention relates to a transaction processing system for handling database based on a hierarchical data model and a concurrency control method in such a transaction processing system.

2. Description of the Related Art

In the transaction processing system, the execution of the processing is managed in units of flows of the processing called transactions. The individual transaction makes an access to the data recorded and managed in files of the database and looks up or updates the data, in the execution process.

In the transaction processing system in general, the performance is improved by processing a plurality of transactions in parallel. In such a case, the system is required to control the accesses made by the transactions such that the execution result in the case of processing a plurality of transactions in parallel is identical to the execution result in the case of processing the individual transactions one by one in some serial order. This fact is expressed as the isolation of transactions is guaranteed, or the execution of transactions is serializable.

In order to guarantee the isolation of transactions, it is necessary to prevent a plurality of transactions processed in parallel to make accesses to the same data. For this reason, the handling of the case where a plurality of transactions simultaneously make accesses to data on a single file is difficult in order to guarantee the isolation. This problem does not arise if the accesses to the same file by a plurality of transactions is prohibited. However, in order to improve the performance of the system by processing a plurality of transactions in parallel, there is a need to allow a plurality of transactions to make accesses simultaneously to data recorded and managed at different portions in a single file.

The most popular scheme for resolving this problem is a lock scheme. In the lock scheme, the data accessed by one transaction is locked until that transaction is finished, such that the other transactions processed in parallel are prevented from making accesses to the data at the same portion on the same file, but accesses to the data at different portions on the same file are allowed. However, in order to realize the lock scheme that guarantees the isolation of transactions, there is a need to resolve a problem called phantom.

The phantom is data that does not exist at that moment, such as data already deleted by the transaction or data that has a possibility of being inserted later on. For example, after one transaction T1 read out data that satisfies a condition P, suppose that another transaction T2 that is processed in parallel deletes or inserts some data that satisfies the condition P. Then, the result obtained by carrying out the reading of the data that satisfies the condition P again by the transaction T1 after the data are updated by the access made by the transaction T2 would be different from the result obtained by carrying out the reading of the data by the transaction T1 before the access made by the transaction T2.

In order to guarantee the isolation of transactions, there is a need to lock the data deleted or inserted by the transaction T2 such that the transaction T1 that is processed in parallel is prevented from making access to the phantom. However, the data to be locked is the phantom which is already deleted or not yet inserted so that it does not exist at a moment of locking. Consequently, the handling of the phantom is difficult.

The major known lock schemes that can resolve the problem of the phantom include an index lock scheme, a predicate lock scheme, and a precision lock scheme (see Jim Gray and Andreas Reuter, “Transaction Processing: Concepts and Techniques”, Morgan Kauffmann, 1993).

In the index lock scheme, a target of locking is not the data itself but an index of the data. The index is based on a value of the data and used in searching the data at high speed, and the known index structures include B-Tree and hash table. In the index lock scheme, a range of indexes that have a possibility of looking up the phantom is locked by utilizing the index structure, so as to resolve the phantom problem and guarantee the isolation of transactions.

In the predicate lock scheme, a target of locking is not the data itself but a predicate that identifies a set of data, so as to resolve the phantom problem. Normally, the access to the data to be made by the transaction is made by using the predicate that identifies that data. In the predicate lock scheme, the predicate used for the access by one transaction is locked, and the already locked predicate is compared with the predicate to be used for the access by the other transaction in order to check if the isolation of transactions would not be broken.

The precision lock scheme is a scheme that improves the predicate lock scheme, which can resolve the phantom problem similarly as the predicate lock scheme. The feature of this precision lock scheme is that, when the transaction requests an access to the data, the predicate used for the access already made by the other transaction and its data are compared. If the data does not satisfy the predicate, the isolation of transactions can be maintained.

As a scheme for managing data sets or files to be processed by the transaction processing, the relational database based on the relational data model has been popular conventionally, but in recent years there is an increasing need for the database that manages data of the hierarchical model. An example of the hierarchical data model includes the XML which is attracting much attentions as a standard format for data to be exchanged on the Internet.

Here, the problems associated with each one of the conventionally known lock schemes, i.e., the index lock scheme, the predicate lock scheme and the precision lock scheme, in the case of carrying out the transaction processing with respect to the database based on the hierarchical data model will be described.

First, in the index lock scheme, the index structure derived from the data files is used. The effective index structure such as B-Tree is known for the relational data model, and conventionally almost all relational databases have adopted the scheme based on the index lock. However, the effective index structure cannot be derived for the hierarchical data model, for the reason such as the parent-child relationship of data is expressed by the tree structure or the overlap of data is permitted. In order to resolve this problem, there is a scheme for converting the hierarchical data model into the relational data model and managing data as the relational database. However, such a scheme has the problems that it cannot efficiently manage the hierarchical structure originally possessed by the data files, and that it is not effective for every hierarchical data model. For this reason, it is difficult to use the index lock scheme with respect to the database based on the hierarchical data model.

In the predicate lock scheme, there is a need to carry out a comparison between predicates in order to check the isolation of transactions. In general, the satisfiability judgement for the predicate is known to be NP complete, so that the implementation of the predicate lock scheme requires an enormous cost.

In the precision lock scheme which is a scheme obtained by improving the predicate lock scheme, the data and the predicate are compared instead of comparing the predicates, so that the required cost is smaller compared with the predicate lock scheme. Also, the precision lock scheme uses a method for checking the isolation at a timing at which the access is requested, rather than a method for locking the predicate used for the access by the transaction in advance, so that it has a superior capability for parallel processing of the transactions. However, there is a problem that the cost is high compared with the index lock scheme, so that schemes based on the index lock scheme have been mainly used conventionally as the relational databases are majority.

Moreover, the precision lock scheme is only known conceptually and there has been no proposition for its implementation method. In order to apply the precision lock scheme to the hierarchical data model, there is a need to check the isolation by judging whether the hierarchical data to be accessed and updated by the transaction satisfies the predicate already used for the access by the other transaction that is processed in parallel or not. However, there has been no proposition of a practical scheme for resolving such a problem.

Currently, in order to guarantee the isolation of transactions with respect to the database based on the hierarchical data model such as the XML data, a scheme for locking the entire data file accessed by the transaction that is processed in parallel is used.

### BRIEF SUMMARY OF THE INVENTION

It is therefore an object of the present invention to provide a transaction processing system and a concurrency control method capable of guaranteeing the isolation of transactions or controlling the order of processing such that the execution of transactions becomes serializable, even in the case where a plurality of transactions make accesses to the hierarchical data in parallel.

According to one aspect of the present invention there is provided a concurrency control method in a transaction processing system for processing a plurality of transactions in parallel with respect to hierarchical data, the concurrency control method comprising: producing a copy of the hierarchical data at a time of starting an access to the hierarchical data by each transaction; judging whether a collision between one of reading access or writing access to be made by a first transaction with respect to a copy of the hierarchical data for the first transaction and another one of reading access or writing access made by the second transaction with respect to a copy of the hierarchical data for the second transaction will occur or not; carrying out a processing for avoiding the collision when the judging step judges that the collision will occur; and reflecting a writing access made by the first transaction with respect to a copy of the hierarchical data for the first transaction, on the hierarchical data, when the first transaction is to be finished normally, and reflecting the writing access also on a copy of the hierarchical data for the second transaction if the second transaction is not finished yet.

According to another aspect of the present invention there is provided a transaction processing system for processing a plurality of transactions in parallel with respect to hierarchical data, comprising: a copying unit configured to produce a copy of the hierarchical data at a time of starting an access to the hierarchical data by each transaction; a judging unit configured to judge whether a collision between one of reading access or writing access to be made by a first transaction with respect to a copy of the hierarchical data for the first transaction and another one of reading access or writing access made by the second transaction with respect to a copy of the hierarchical data for the second transaction will occur or not; a processing unit configured to carry out a processing for avoiding the collision when the judging unit judges that the collision will occur; and a reflecting unit configured to reflect a writing access made by the first transaction with respect to a copy of the hierarchical data for the first transaction, on the hierarchical data, when the first transaction is to be finished normally, and reflect the writing access also on a copy of the hierarchical data for the second transaction if the second transaction is not finished yet.

According to another aspect of the present invention there is provided a computer program product for causing a computer to function as a transaction processing system for processing a plurality of transactions in parallel with respect to hierarchical data, the computer program product comprising: a first computer program code for causing the computer to produce a copy of the hierarchical data at a time of starting an access to the hierarchical data by each transaction; a second computer program code for causing the computer to judge whether a collision between one of reading access or writing access to be made by a first transaction with respect to a copy of the hierarchical data for the first transaction and another one of reading access or writing access made by the second transaction with respect to a copy of the hierarchical data for the second transaction will occur or not; a third computer program code for causing the computer to carry out a processing for avoiding the collision when the second computer program code judges that the collision will occur; and a fourth computer program code for causing the computer to reflect a writing access made by the first transaction with respect to a copy of the hierarchical data for the first transaction, on the hierarchical data, when the first transaction is to be finished normally, and reflect the writing access also on a copy of the hierarchical data for the second transaction if the second transaction is not finished yet.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of a transaction processing system according to one embodiment of the present invention.

FIG. 2 is a diagram showing one exemplary XML document that can be handled by the transaction processing system of FIG. 1.

FIG. 3 is a diagram showing another exemplary XML document that can be handled by the transaction processing system of FIG. 1.

FIG. 4 is a diagram showing another exemplary XML document that can be handled by the transaction processing system of FIG. 1.

FIG. 5 is a diagram showing another exemplary XML document that can be handled by the transaction processing system of FIG. 1.

FIG. 6 is a diagram showing one exemplary transaction management table used in the transaction processing system of FIG. 1.

FIG. 7 is a block diagram showing a first exemplary configuration of a resource manager used in the transaction processing system of FIG. 1.

FIG. 8 is a diagram showing one exemplary transaction list used in the resource manager of FIG. 7.

FIG. 9 is a diagram showing one exemplary transaction waiting graph used in the resource manager of FIG. 7.

FIG. 10 is a diagram showing one exemplary transaction access sequence used in the resource manager of FIG. 7.

FIG. 11 is a flow chart showing an exemplary processing procedure at a time of starting the processing of the transaction in the transaction processing system of FIG. 1.

FIG. 12 is a flow chart showing an exemplary processing procedure when the transaction requested the reading access in the transaction processing system of FIG. 1.

FIG. 13 is a flow chart showing an exemplary processing of a function Eval used in the processing of FIG. 12.

FIG. 14 is a flow chart showing an exemplary processing procedure when the transaction requested the writing access in the transaction processing system of FIG. 1.

FIG. 15 is a diagram showing an exemplary transaction access sequence used in the processing of FIG. 14.

FIG. 16 is a diagram showing exemplary transactions currently processed in parallel used in the processing of FIG. 14.

FIG. 17 is a block diagram showing a second exemplary configuration of a resource manager used in the transaction processing system of FIG. 1.

FIG. 18 is a diagram showing an exemplary transaction access sequence used in the resource manager of FIG. 17.

FIG. 19 is a diagram showing exemplary transactions currently processed in parallel used in the resource manager of FIG. 17.

FIG. 20 is a diagram showing an exemplary S-Point management table used in the resource manager of FIG. 17 in one state.

FIG. 21 is a diagram showing an exemplary S-Point management table used in the resource manager of FIG. 17 in another state.

FIG. 22 is a flow chart showing an exemplary processing procedure for a WR access collision check when the transaction requested the writing access in the resource manager of FIG. 17.

FIG. 23 is a flow chart showing an exemplary processing procedure for an S-Point setting in the resource manager of FIG. 17.

FIG. 24 is a diagram showing an exemplary S-Point management table used in the resource manager of FIG. 17 in four states.

### DETAILED DESCRIPTION OF THE INVENTION

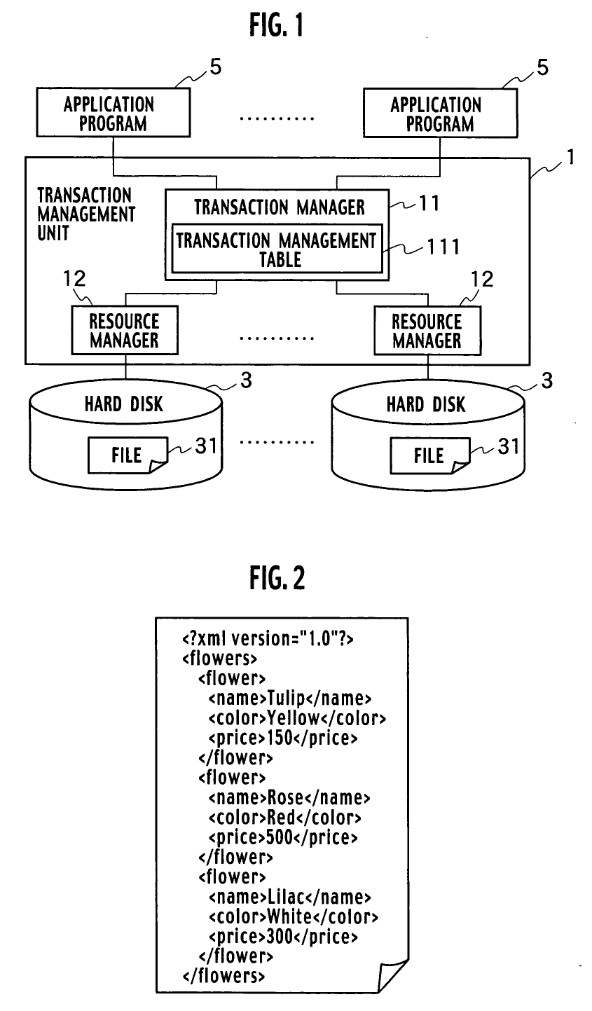

Referring now to FIG. 1 to FIG. 24, the embodiments of the transaction processing system according to the present invention will be described in detail.

FIG. 1 shows an exemplary configuration of the transaction processing system according to one embodiment of the present invention, which comprises a transaction management unit 1, application programs 5 and hard disks 3 storing files 31. The transaction management unit 1 has a transaction manager 11 with a transaction management table 111, and resource managers 12.

Note that the hard disks 3 may be provided in the transaction processing system, or the hard disks 3 may be provided in the other server or the like such that the transaction processing system is accessible to the hard disks 3 through the other server or the like. Also, the application programs 5 may be executed on the transaction processing system, or the application programs 5 may be executed on the other computer and a client server system may be formed by the other computer as a client and the transaction processing system as a server.

The hard disks 3 shown in FIG. 1 record the files 31 of data to be accessed by the transactions. Here, the exemplary case of the transaction processing system for processing files that record data in forms of documents in the XML format which is an example of the hierarchical data model will be described. Further details of the XML can be found in “Extensible Markup Language (XML) 1,0”, W3C Recommendation 10, Feb. 1998,

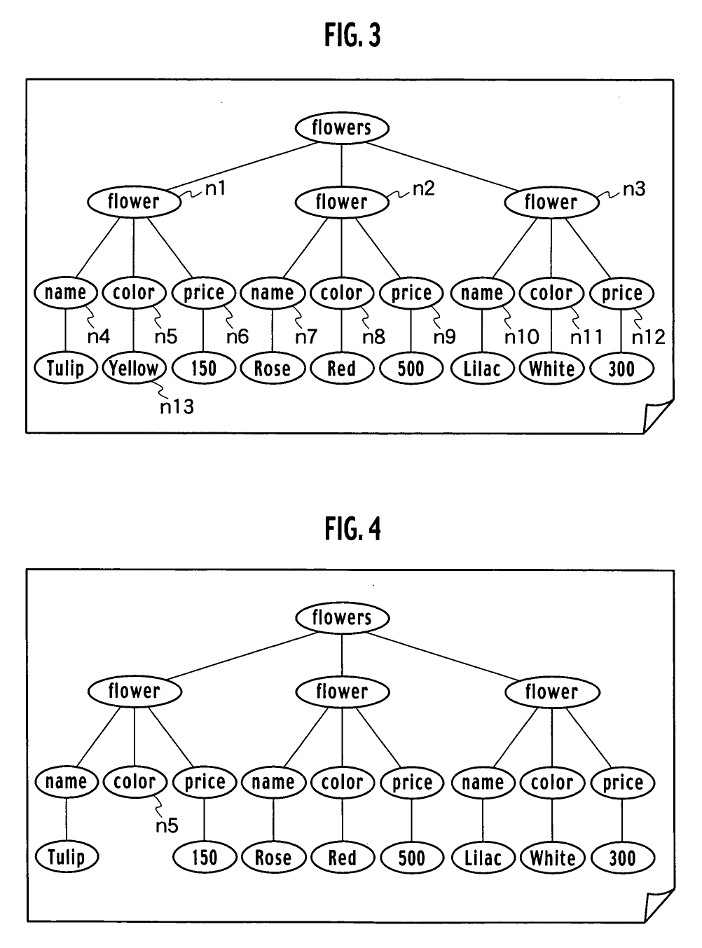

The document format of the files 31 recorded in the hard disks 3 can be the text format or the tree format. FIG. 2 shows an exemplary XML document in the text format. The actual XML document has a prologue section that starts from <?xml>, but it is omitted here. FIG. 3 shows an exemplary document in the tree format which expresses the same data as FIG. 2.

The document in the text format shown in FIG. 2 is enclosed by tags <flowers> and </flowers>. The outermost tags enclosing the document in the text format correspond to the root of the tree in the document in the tree format. For example, in the document in the tree format shown in FIG. 3, a node with a name “flowers” is the root of the tree.

The hierarchical relationships among data are expressed by relationships of nested tags in the document in the text format, and by parent-child relationships among nodes in the document in the tree format. For example, in FIG. 2, there are three sets of nested tags <flower> and </flower> inside the tags <flowers> and </flowers>, and in FIG. 3, there are three children nodes with a name <flower> under the root node of the tree. In the document of FIG. 2, there are three sets of tags for “name”, “color”, and “price” inside the tags for “flower”, and the data enclosed by the “name” tags inside the first “flower” tags is “Tulip”. In the document of FIG. 3, the name of the leaf node of the tree which is a child of the “name” node which is a child of the first “flower” node is “Tulip” that indicates the data value.

In the following, the exemplary case where each file is recorded as the document in the tree format will be described, but the case where each file is recorded as the document in the text format can be realized by adding a conversion to the tree structure, for example.

The application programs 5 shown in FIG. 1 make accesses to the files 31 recorded in the hard disks 3 and carry out operation (reading or writing) of the data. To this end, the transactions are issued and the processings of the transactions are carried out through the transaction management unit 1.

The problem handled by the concurrency control scheme of this embodiment is the problem of carrying out the parallel processings of a plurality of transactions that make accesses to the same file while maintaining the isolation. In the following description of the concurrency control method of this embodiment, the case where the transaction makes an access to only one file in the course of its execution will be mainly described. The ordinary transaction can carry out the operation of the data by making accesses to a plurality of files, and such a case where one transaction makes accesses to a plurality of files can be realized similarly by treating the processing for each access target file of the transaction separately.

The access made by the transaction can be a reading access for the purpose of looking up data or a writing access for the purpose of updating data (inserting, deleting, or changing a value, for example). The transaction in this embodiment comprises an access sequence formed by one or a plurality of reading accesses and writing accesses to be made with respect to one file.

First, the reading access by the transaction carries out an operation of READ(path). In the hierarchical data model in general, the data to be looked up (the node corresponding to the data in the case of the tree format) can be specified by using the predicate in the path expression. For example, in order to specify the data or the data set at one portion on the XML document, the language in the path expression of XPath is often used. Further details of XPath can be found in “XML Path Language (XPath) 1.0”, W3C Recommendation 16 Nov. 1999. The “path” in the READ(path) is the predicate in the path expression such as XPath. The READ(path) is an operation that returns the node or the node set on the document specified by the “path”.

The transaction reads out the data value desired to be looked up, from the node returned as a result of the READ(path). For example, path=“flower[name=Tulip]/color” is an example using the XPath language, which is the predicate for specifying the child node “color” of “flower” that satisfies the condition of [name=Tulip]. When the transaction carries out the operation of READ(“flower[name=Tulip]/color”) as the reading access with respect to the document of FIG. 3, the node n5 of FIG. 3 is returned as a result. The transaction can read out “Yellow” from the value of the node n5 (the name of the child node in the case of the tree format). As another example, when the transaction carries out the operation of READ(“flower[price<400]/name”) with respect to the document of FIG. 3, the node set {node n4, node n10} is returned. The transaction can read out data “Tulip” and “Lilac” from the values of these nodes.

In the writing access by the transaction, it is assumed here that it is possible to carry out three types of operations including INSERT, DELETE and REPLACE. Note that only the above described three operations are mentioned here as the operations of the writing access by the transaction, but it is also possible to use the other operations for updating the nodes of the document, and the concurrency control scheme of this embodiment can be realized similarly even in such a case.

In the following, each one of the INSERT operation, the DELETE operation, and the REPLACE operation will be described in detail.

The INSERT(node, data) is an operation for inserting a value specified by “data” into a value of a node specified by “node”. For example, when the operation of INSERT(node n5, “Yellow”) is carried out as the writing access with respect to the document of FIG. 4, the document as shown in FIG. 3 can be obtained as a result of reflecting that update.

The INSERT(node, child-node) is an operation for inserting a node specified by “child-node” as a chile node of a node specified by “node”. Besides this operation, it is also possible to use various other INSERT operations such as an operation for inserting a node as the n-th child node, an operation for inserting a node in front of a node specified by “node” as a sibling node, an operation for inserting a node behind a node specified by “node” as a sibling node, etc., for example.

The DELETE(node) is an operation for deleting a node specified by “node”. For example, when the operation of DELETE(node n13) is carried out as the writing access with respect to the document of FIG. 3, the document as shown in FIG. 4 can be obtained as a result of reflecting that update.

The REPLACE(node, data) is an operation for changing a value of a node specified by “node” to a value specified by “data”. For example, when the operation of REPLACE(node n5, “Red”) is carried out as the writing access with respect to the document of FIG. 3, the document as shown in FIG. 5 can be obtained as a result of reflecting that update.

The case of using operations different from these INSERT, DELETE and REPLACE can be realized similarly. For example, it is possible to give an attribute to a node of the XML document. In this case, it is possible to add an operation such as INSERT(node, attr, value) for inserting a value specified by “value” to an attribute with a name “attr” of a node specified by “node”.

Now, when the transaction carries out the update of data, there is a need to carry out the operation of the reading access to specify a data to be updated, and then the operation of the writing access with respect to that data. Namely, the writing access is made after the reading access, with respect to the node or the node set returned as a result of that reading access. For example, in the case where the transaction updates a value of “color” of “Tulip” in the document of FIG. 3 to “Red”, the reading access READ(“flower[name=Tulip]/color”) is carried out first, and then the writing access REPLACE(node n5, “Red”) is carried out with respect to the node n5 returned as a result of the reading access.

Note that the exemplary case of carrying out the writing access with respect to one node is described here, but the case of carrying out the writing access with respect to the node set can be realized similarly by carrying out the update with respect to the individual node.

The transaction management unit 1 of FIG. 1 carries out the processing of the transaction executed by each application program 5. The transaction management unit 1 includes the transaction manager 11 and the resource managers 12. The transaction manager 11 carries out the management of all the transactions issued from the application programs 5. On the other hand, the resource managers 12 carry out the management of the files 31 on the database and the processing of access made by each transaction with respect to these files 31.

FIG. 1 shows an exemplary case where the transaction management unit 1 includes a plurality of resource managers 12. Here, each resource manager 12 is responsible for the individual file 31 on the database, and carries out the processing of access made by the transaction with respect to the file 31 for which it is responsible. Of course it is not necessarily limited to this configuration, and other configuration may be used. For example, it is possible to use the transaction management unit 1 that includes one transaction manager 11 and one resource manager 12, where this one resource manager 12 carried out the processing of accesses made by the transaction with respect to all the files 31. It is also possible to use the transaction management unit 1 that includes one transaction manager 11 and a plurality (lesser number) of resource managers 12, where at least one resource manager 12 carries out the processing of accesses by the transaction with respect to a plurality of files 31.

The transaction manager 11 of FIG. 1 manages all the transactions issued by the application programs 5. Also, the individual transaction issued by the application program 5 is set in correspondence to the resource manager 12 that manages the file 31 to be accessed by that transaction. Then, the processing of access made by each transaction is commanded to the corresponding resource manager 12. The transaction manager 11 carries out the creation or the deletion of the resource manager 12 according to the creation or the deletion of the file 31.

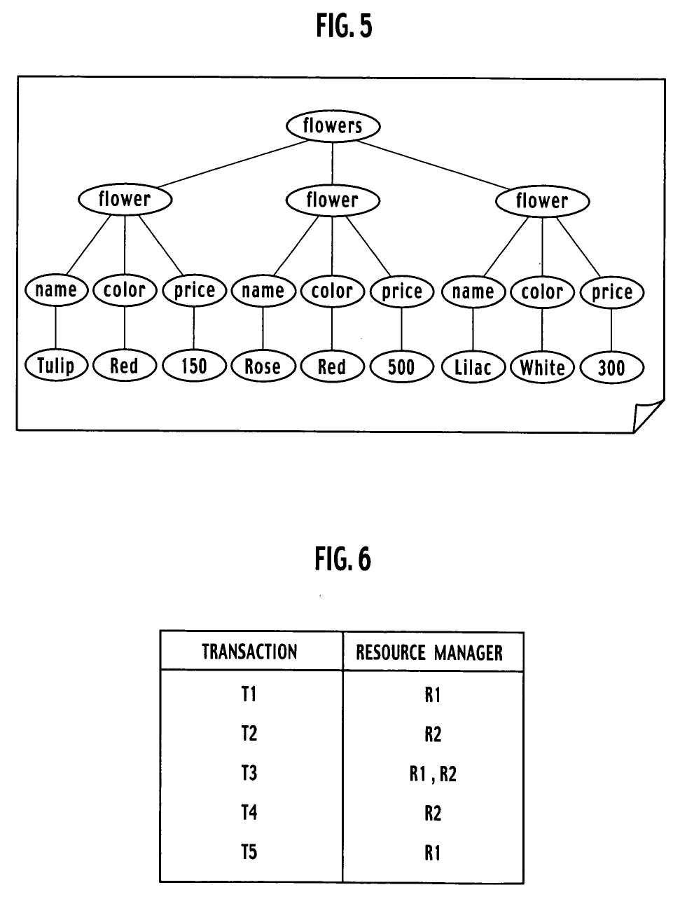

The transaction management table 111 of FIG. 1 manages which transaction corresponds to which resource manager 12. The transaction management table 111 records information indicating a transaction identifier of the transaction and an identifier of the resource manager 12 that manages the file 31 to be accessed by that transaction. For example, an example of the transaction management table shown in FIG. 6 indicates that three transactions with the transaction identifiers T1, T3 and T5 are making accesses to the file 31 managed by the resource manager with an identifier R1.

In the following, the processing procedure in the exemplary case where each transaction makes an access to one file 31, and is set in correspondence to one resource manager 12 that manages that file 31 will be described. The concurrency control scheme of this embodiment is carries out by the individual resource manager that carries out the processing of access made by the transaction with respect to each file 31, so that it can be realized similarly in the case where each transaction corresponds to a plurality of resource managers.

Here, the processing procedure carried out by the transaction manager 11 will be described in an order of (1) the processing procedure when the transaction is issued, (2) the processing procedure when the transaction requests the reading access or the writing access, and (3) the processing procedure when the processing of the transaction is to be finished.

(1) Processing Procedure when the Transaction is Issued:

When the application program 5 issues a new transaction and the file 31 to be accessed by that transaction is notified to the transaction manager 11, the transaction manager 11 allocates a transaction identifier to the new transaction first. Also, the resource manager 12 that is managing the file 31 to be accessed by that transaction is checked, and the information on the transaction identifier and the identifier of the corresponding resource manager 12 is recorded into the transaction management table 111. Then, the start of the processing of the new transaction is commanded to the corresponding resource manager 12.

(2) Processing Procedure when the Transaction Requests an Access:

When the reading access or the writing access is requested in the course of carrying out the execution of the transaction by the application program 5, the transaction manager 11 notifies the transaction identifier and the access request of that transaction to the corresponding resource manager 12.

(3) Processing Procedure when the Processing of the Transaction is to be Finished:

When the application program 5 notifies the finishing of the processing of the transaction, the transaction manager 11 checks the resource manager 12 that is processing that transaction by using the transaction identifier, and determines to either commit the transaction by writing the update result of the data made by the transaction into the file 31 on the hard disk 3 or abort the transaction by discarding the update result, and commands it to the corresponding resource manager 12. Note that the method for determining either to commit or to abort can be the conventionally known method. Also, an entry of that transaction identifier is deleted from the transaction management table 111.

The resource manager 12 of FIG. 1 manages the file 31 on the corresponding hard disk 3, and carries out the processing of access by the transaction when it is commanded from the transaction manager 11. At a time of carrying out the processing of access by the transaction, the concurrency control scheme of this embodiment is carried out such that the processing is carried out while maintaining the isolation of transactions.

In the concurrency control scheme of this embodiment, when one transaction requests the reading access or the writing access, whether the isolation of transactions is broken as that access is made with respect to the data at the same portion of the same file as the reading access or the writing access carried out by the other transaction that is processed in parallel to that transaction, or not is checked.

Here, the situation in which two accesses are made with respect to the data at the same portion of the same file will be expressed as two accesses collide.

In the case of the collision between the reading access and the reading access, the isolation is not broken even if the data of the same portion is read out simultaneously, so that this check is unnecessary.

On the other hand, in the case of the collision between the reading access and the writing access, the isolation would be broken if the reading and the writing of the data at the same portion are carried out simultaneously, so that this check is necessary.

Similarly, the isolation would be broken in the case of the collision between the writing access and the writing access. However, the writing access with respect to one data is always preceded by the reading access with respect to that data, so that the collision between the writing access and the writing access that break the isolation can be discovered by checking the collision between the reading access and the writing access, and therefore this check is unnecessary in this case.

As a result of the access collision check, if the access requested by one transaction T1 cause the collision with the access already made by the other transaction T2 such that the isolation would be broken, the processing of one of these transactions must be interrupted until the processing of the other one of these transactions is finished. At that point, the transaction to be interrupted can be determined depending on which transaction is to be processed at higher priority. For example, it is possible to use a method in which a higher priority is given to the earlier transaction T2 so that the later transaction T1 is interrupted and resumed after the transaction T2 is finished, a method in which the priority level is assigned to each transaction in advance and the priority levels of the collided transactions are compared to determine which transaction is to be processed at higher priority, etc.

In this embodiment, at a time of carrying out the processing for access by the transaction with respect to the file managed by the individual resource manager, the access collision check is carried out. The method of the access collision check to be used in this embodiment will be described in further detail below.

In the following, two exemplary configurations for the resource manager that carries out the concurrency control scheme of this embodiment will be described.

(First Exemplary Configuration of the Resource Manager)

First, the first exemplary configuration of the resource manager will be described.

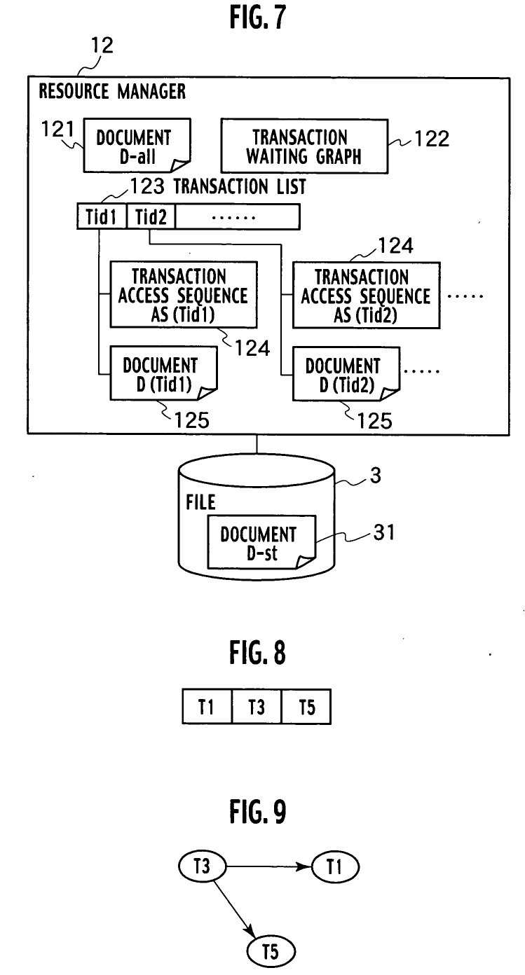

FIG. 7 shows the first exemplary configuration of the resource manager 12, which has a document D-all 121, a transaction waiting graph 122, a transaction list 123, transaction access sequences 124, and documents D(Tid) 125, with respect to the document D-st 31 stored in the hard disk 3.

The resource manager 12 manages one file, and carries out the processing of accesses by a plurality of transactions with respect to that file. The document D-st 31 in FIG. 7 is the file on the hard disk 3 that is managed by the resource manager 12. The documents in the following description are all documents in the tree format similarly as the file D-st 31.

The document D-all 121 in FIG. 7 is a document for maintaining the content in the case of reflecting all the update results of the data made until then by all the transactions currently processed, with respect to the file 31 managed by the resource manager 12. The resource manager 12 creates the document D-all 121 by copying the document D-st in the initial state. Thereafter, the resource manager reflects the update of the data made by the writing access on the document D-all sequentially if it is judged that the writing access requested by the transaction currently processed does not break the isolation.

The transaction list 123 of FIG. 7 records and manages a list of the transaction identifiers of the transactions processed by the resource manager 12. For example, an example of the transaction list shown in FIG. 8 indicates that the resource manager 12 with the identifier R1 as in the example of FIG. 6 is carrying out the processings of three transactions with the transaction identifiers T1, T3 and T5 in parallel. The resource manager 12 manages the transaction access sequence AS(Tid) 124 and the document D(Tid) 125 with respect to the individual transaction with the transaction identifier Tid that is currently processed.

The transaction waiting graph 122 of FIG. 7 is a waiting graph that records and manages information on the transaction identifiers of the transactions whose processings are interrupted and kept waiting by the resource manager 12. Each vertex in the transaction waiting graph 122 indicates the transaction, and each edge in the transaction waiting graph 122 indicates the dependency relationship among the transaction execution orders.

FIG. 9 shows an example of the transaction waiting graph 122. For example, an edge (T3→T1) in FIG. 9 indicates that the processing of the transaction T1 is interrupted and kept waiting until the processing of the transaction T3 is finished. If the access of the transaction T1 collides with the access of the transaction T3, the transaction T1 must be kept waiting until the processing of the transaction T3 is finished, so that the resource manager 12 adds the edge (T3→T1) to the transaction waiting graph 122. Then, when the processing of the transaction T3 is to be finished, the edges having T3 as a starting tervex are deleted, and the processings of the transactions at end vertexes of these edges are resumed.

The transaction waiting graph 122 is also widely used in order to resolve the dead lock. The dead lock state can be detected by detecting a loop in the transaction waiting graph 122.

In this embodiment, the transaction waiting graph 122 is used for the purpose of recording and managing the waiting information of the transaction, but it is also possible to use the other methods.

The transaction access sequence AS(Tid) 124 of FIG. 7 records and manages a sequence of the reading accesses and the writing accesses made by the individual transaction Tid since the start of its processing, as a list. The transaction access sequence 124 records the access number of each access, information indicating whether each access if the reading access or the writing access, and information indicating the operation of each access, in an order of accesses. AS(Tid) indicates the transaction access sequence for the transaction with the transaction identifier Tid.

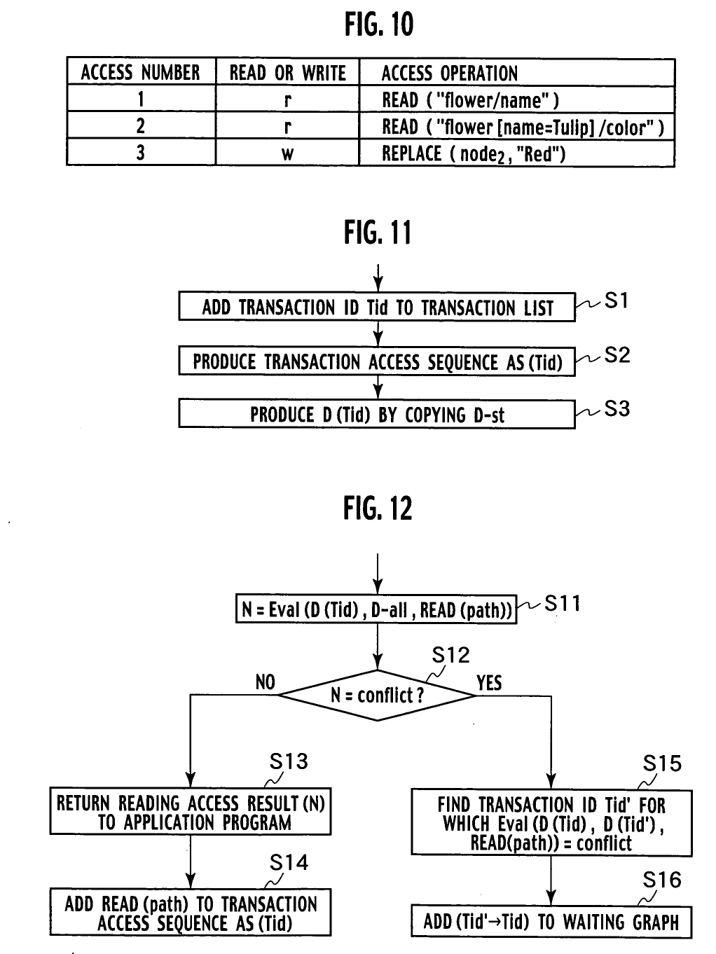

FIG. 10 shows an example of the transaction access sequence. In FIG. 10, “r” indicates that it is the reading access, and “w” indicates that it is the writing access. The transaction that has the exemplary transaction access sequence of FIG. 10 carries out the reading access READ(“flower/name”) of the access number 1 first, the reading access READ(“flower[name=Tulip]/color”) of the access number 2 next, and the writing access REPLACE(node2, “Red”) of the access number 3 finally. Here, “node2” indicates the node returned as a result of the reading access of the access number 2. As the operation target node at a time of making the writing access, it is possible to specify the node, the node set or a part of the node set obtained as a result of the reading access that was made earlier.

The document D(Tid) 125 of FIG. 7 is a document which reflects the update result of the data by the writing access made by the transaction with the transaction identifier Tid. Note that, in the following description, this document is also referred to as the document D (corresponding to that transaction) by omitting the transaction identifier Tid. In contrast to the document D-all which reflects all the updates of the data made by all the transactions processed by the resource manager 12, this document D reflects the updates of the data made by one corresponding transaction.

The resource manager 12 creates the document D for the new transaction by copying the document D-st, that is the file it manages, at a time of starting the processing of the transaction. Thereafter, when that transaction requests the reading access or the writing access, the look up or the update of the data is made by accessing the document D instead of the document D-st on the hard disk 3, if it is judged that this access does not break the isolation. Then, when this transaction is to be finished by committing the transaction, the updates made in the document D corresponding to this transaction are merged to the document D-st such that the update results of the data to be committed are reflected in the file 31 on the hard disk 3. On the other hand, when this transaction is to be finished by aborting the transaction, the update results by this transaction are discarded and the document D is deleted.

When the access is requested from the transaction, the resource manager 12 must judge whether that access breaks the isolation or not. When the transaction requests the reading access, whether that access causes the collision by accessing the same portion as the data for which the writing access was already made by the other transaction currently processed in parallel or not is checked. Also, when the transaction requests the writing access, whether that access causes the collision by accessing the same portion as the data for which the reading access was already made by the other transaction currently processed in parallel or not is checked. Hereafter, the situation in which the reading access collides with the already made writing access will be referred to as “RW access collision”, and the situation in which the writing access collides with the already made reading access will be referred to as “WR access collision”.

(Check of the RW Access Collision)

First, the check of the RW access collision will be described.

The RW access collision occurs when the reading access requested by one transaction T1 collides with the writing access already made by the other transaction currently processed in parallel.

In the conventional predicate lock scheme or the precision lock scheme, this collision is detected by the comparison of the predicate and the predicate or the comparison of the predicate and the data. However, it is very difficult to Judge whether the data already updated by the other transaction satisfies the “path” of the XPath expression in the reading access READ(path) of the transaction T1 or not.

In the concurrency control scheme of this embodiment, the access collision check can be realized efficiently by using only the comparison of the data and the data.

First, the case where the reading access requested by one transaction T1 causes the RW access collision with the writing access already made by the other transaction T2 will be considered. In this case, the access collision occurs as the reading access requested by the transaction T1 looks up the data at the same portion as the data already updated by the transaction T2.

When the reading access is made by the transaction T1, the reading operation READ(path) with respect to the document D(T1) is carried out, and the node set on the document D(T1) identified by “path” is returned as a result of the reading access. In order to identify the node set of the result by evaluating the XPath expression, there is a need to search a corresponding node while tracing a route on the document D(T1) in the tree structure along the description of the “path”, and the node set of the result is obtained at the last step of the search route. Consequently, the reading access looks up all the nodes on the route reaching to the node set of the result. The set of these nodes that are looked up by the reading access of the transaction T1 will be denoted as N1.

The update result of the writing access already made by the transaction T2 is reflected in the document D(T2). The document in which the update result already made by the transaction T2 is reflected on the document D(T1) can be obtained by merging the documents D(T1) and D(T2). Here, the merging of two documents D(T1) and D(T2) implies that the update results made by the transactions T1 and T2 are both reflected in the merged document. The set of nodes looked up when the reading access READ(path) is made with respect to the merged document similarly will be denoted as N2.

When the RW access collision occurs, the data at the same portion as the node set N1 on the document D(T1) in the merged document is updated by the transaction T2, so that the node set N1 and the node set N2 are different. Here, when the nodes on the different documents D(T1) and D(T2) are equivalent, it implies that these nodes are copied from the same node on the document D-st. For example, when the data at the same portion as the data deleted by the transaction T2 is to be looked up by the READ(path) of the transaction T1, the node existing in the node set N1 to be looked up does not exist in the node set N2. When the node set N1 and the node set N2 are identical, it implies that these node sets have all of their constituent elements equivalent, and it is said that the node set N1 and the node set N2 are equivalent.

The RW access collision check is equivalent to checking whether the node set to be looked up at a time of evaluating the “path” of READ(path) with respect to the document D(T1) and the node set to be looked up at a time of evaluating the “path” of READ(path) with respect to the document in which the document D(T1) and the document D(T2) are merged are equivalent or not.

Next, the equivalency check for the node sets to be looked up at a time of evaluating the “path” of the reading accesses READ(path) with respect to two different documents will be described in detail.

For example, when READ(“flower/color”) is made with respect to the document of FIG. 3, the child nodes {node n1, node n2, node n3} (=node set R1) with the name “flower” are searched first. Then, using these nodes as the starting points (called “context nodes” in the specification of the XPath), the child nodes {node n5, node n8, node n11}(=node set R2) with the name “color” are searched. In this case, the node set R2 of the result is identified by tracing the route of the node set R1→the node set R2, so that both of the node set R1 and the node set R2 are looked up in the evaluation of the “path”. Consequently, in order to check whether the node sets to be looked up by the reading accesses with respect to different documents are equivalent or not, it suffices to compare the node sets on the respective documents to be looked up at each step on the search router of the “path” and check whether they are equivalent or not.

When the node sets to be looked up by the reading accesses with respect to two documents are equivalent in the RW access collision check, all the node sets to be looked up at a time of evaluating the “path” by the reading access, that is, the node sets to be looked up at all steps on the search route of the “path” are equivalent.

Now, it is also possible to carry out the RW access collision check efficiently, without comparing the node sets at all the steps. This method will be described in the following.

In each document, if the parent node on the tree is updated by the writing access, its child nodes are also updated. The operations of the writing access with respect to the document includes three major operations, that is, INSERT, DELETE, and REPLACE operations. For example, when the INSERT operation is carried out by the transaction T2 with respect to the document D(T2), all the nodes existing in a partial tree that has the inserted node as the root in the document tree of the document D(T2) are also nodes newly inserted by the transaction T2. Also, when the DELETE operation is carried out by the transaction T2, the deleted node and a partial tree that has that node as the root do not exist on the document tree of the document D(T2). Also, the data value is stored in the leaf node of the document tree, so that the REPLACE operation for updating the value is carried out only with respect to the leaf node. Even in the case of considering the REPLACE operation for updating the name of the node that is not the leaf node of the tree, it can be considered similarly by assuming that the partial tree that has that node as the root is also to be changed.

In this way, when the parent node is updated by the writing access on one document tree, its child nodes are also updated, so that when the node sets looked up at one step on the search route of the “path” are different, the node sets searched by tracing the partial trees starting from these node sets at the next step are also different.

For this reason, as long as each step continues the search downwards in the tree, there is no need to check the equivalency by comparing the node sets that are looked up at the intermediate steps.

However, besides the downward search for searching the child nodes and the descendant nodes that satisfy a specified condition, the XPath also uses the search in different directions for searching the parent node and the sibling nodes. At the step immediately before the direction of the search is changed, there is a need to check the equivalency by comparing the node sets that are looked up.

For example, when READ(“flower[name=Tulip]/color”) is made with respect to the document of FIG. 3, the search route that reaches to the result is {node n4} (=node set R11)→{node n1} (=node set R12)→{node n5} (=node set R13), and the search from the node set R11 to the node set R12 is not downwards, so that there is a need to compare the nodes in the node set R11, but the search from the node set R12 to the node set R13 is downwards, so that the comparison of the nodes in the node set R12 can be omitted (because if the nodes are different by the comparison in the node set R12, the nodes are also different by the comparison in the node set R13, so that it suffices to carry out only the comparison in the node set R13). In this case, it suffices to check the equivalency of the node sets only at the steps that looked up the node set R11 and the node set R13.

The cases where the equivalency check of the node sets that are looked up at the intermediate step must be carried out as the direction of the search is changed in the evaluation of the XPath expression can be classified into the following three cases.

The first case is the case where a plurality of paths exist in one XPath expression. In this case, the equivalency of the node sets obtained by evaluating each one of these paths is checked. For example, the specification of the XPath includes various operators and functions such as “+” and “−”, so that two paths path₁ and path₂ can exist in one “path” as in an exemplary case of path=path₁+path₂. Consequently, the equivalency check is carried out for each one of the node set that is looked up by path₁ and the node set that is looked up by path₂.

The second case is the case where the search direction is changed to a direction that is not downward within one path, as described above. In the XPath, the direction of the search can be set by specifying an axis. For example, the direction of the search can be set such that the parent node and the ancestor nodes for the context nodes are searched. Besides that, the axis for the direction of the search that is not downward includes that for searching the preceding sibling node and that for searching the following sibling node.

The third case is the case in which the search is carried out by the position information of the node specified by the XPath. For example, in the case of searching the second “flower” node as in an exemplary case of path=flower[position( )=2], the equivalency check of the node sets is carried out by including the first node that affects that position also as a target of looking up.

As described, the RW access collision that is caused by the reading access of the transaction T1 with respect to the writing access of the transaction T2 is detected by checking whether the node sets that are looked up by evaluating READ(path) with respect to the document D(T1) and the document obtained by merging the document D(T1) and the document D(T2) are equivalent or not.

Now, in order to guarantee the isolation of transactions, there is a need to check whether the requested reading access causes the RW access collision or not, with respect to all the other transactions currently processed in parallel. For example, when the transaction T1 requests the reading access, the RW access collision check must be carried out with respect to all the transactions other than the transaction T1 that are currently processed. This can be realized by a method in which the RW access collision check between the transaction T1 and another one transaction currently processed in parallel is repeatedly carried out for all the transactions other than the transaction T1 that are currently processed in parallel, or a method for carrying out the equivalency check for the node sets looked up by the reading access with respect to the document D(T1) and the node sets looked up by the reading access with respect to the document obtained by merging the document D(T1) with all the documents D for the other transactions.

In this embodiment, the RW access collision check can be processed even more efficiently by using the document D-all. Namely, the update results of the data made by all the transactions are reflected on one document D-all. Consequently, the necessary RW access collision check can be realized by a single operation of checking whether the node sets looked up by the reading access with respect to the document D(T1) and the node sets looked up by the reading access with respect to the document D-all are equivalent or not.

(Check of the WR Access Collision)

Next, the check of the WR access collision will be described.

The WR access collision check is carried out by the comparison of the node sets and the node sets, similarly as in the RW access collision check.

The WR access collision occurs when the writing access requested by one transaction T1 collides with the reading access already made by the other transaction T2. This collision occurs when the transaction T1 requests the writing access with respect to the data at the same portion as the data looked up by the reading access already made by the transaction T2. The operation of the writing access requested by the transaction T1 will be denoted as W. Note that W is any one of INSERT, DELETE and REPLACE operations.

First, the state of the document D(T2) at a timing at which the transaction T2 made some reading access READ(path) before is set as D′(T2), and the node set looked up at a time of evaluating the “path” by READ(path) with respect to the document D′(T2) is set s N11.

Next, the document in which the update results made by the transaction T1 until then including the writing access W are reflected on the document D′(T2) is set as D″(T2), and the node set looked up by making the same reading access READ(path) with respect to the document D″(T2) is set as N12.

When the WR access collision occurs as the writing access W requested by the transaction T1 and the reading access READ(path) made by the transaction T2 before collide, the data at the same portion as the data looked up by READ(path) of the transaction T2 will be updated by the writing access W of the transaction T1 in the document D″(T2), so that the node sets N11 and N12 that are looked up by the reading accesses with respect to the two documents D′(T2) and D″(T2) are different.

Consequently, the WR access collision check is equivalent to checking whether the node set looked up by READ(path) with respect to the document D′(T2) and the node set looked up by READ(path) with respect to the document D″(T2) are equivalent or not.

In order to guarantee the isolation of transactions, whether the requested writing access causes the WR access collision with respect to all the reading accesses already made by the other transactions currently processed in parallel or not is checked. For example, when the transaction T1 requests the writing access, the WR access collision check is carried out for all the reading accesses already made by the transactions other than the transaction T1 in the transaction list 123.

First, the document D″(T2) at a timing at which each reading access was made is the document in which the update results of all the writing accesses already made before that reading access are reflected on the document D-st, so that it can be re-created by a method of making the writing accesses of the transaction access sequence for the transaction T2 with respect to the document D-st. The node set N11 looked up by each reading access READ(path) can be obtained by obtaining the node set that is looked up by READ(path) with respect to the re-created document D′(T2).

Alternatively, it is also possible to store the node set N11 that is looked up for every reading access.

Next, the state of the document D(T1) in which the update by the writing access W is reflected is set as D′(T1). Then, the document D″(T2) in which the update results by the transaction T1 including the writing access W until then are reflected can be obtained by merging the documents D′(T1) and D′(T2).

Alternatively, it is also possible to re-create the document D″(T2) by carrying out the writing accesses of the transaction access sequence for the transaction T2 with respect to the document D′(T1).

In the resource manager in the first exemplary configuration of FIG. 7, the state of the document D at a time of the already made reading access is re-created while tracing the transaction access sequence 124 with respect to the document D-st, that is, while sequentially executing the reading accesses and the writing accesses of the transaction access sequence 124 for the transaction, and the equivalency judgement for the node sets looked up by the reading access READ(path) is carried out at the time of the WR access collision check.

Alternatively, it is also possible to record the state of the document D before the update at a time of updating the document D by making the writing access of the transaction. In this case, there is no need to re-create the document D, but there is a trade off that a recording capacity required in recording the state at each occasion of the update of the document D becomes large. In the resource manager 12 in the second exemplary configuration to be described below, the WR access collision check is carried out while scheduling the timings for recording the state of the document D.

In the following, the processing procedure to be carried out by the resource manager 12 in this exemplary configuration will be described in an order of (1) the processing procedure at a time of starting the processing of the transaction, (2) the processing procedure when the transaction requested the reading access, (3) the processing procedure when the transaction requested the writing request, (4) the processing procedure at a time of resuming the transaction after the interruption, (5) the processing procedure at a time of committing the transaction, and (6) the processing procedure at a time of aborting the transaction.

(1) Processing Procedure at a Time of Starting the Processing of the Transaction:

FIG. 11 shows an exemplary processing procedure at a time of starting the processing of the transaction with the transaction identifier Tid.

First, the transaction identifier Tid is added to the transaction list 123 (step S1). Also, the transaction access sequence AS(Tid) and the document D(Tid) are created for the new transaction (steps S2, S3).

Note that the initial value of the transaction access sequence is an empty list.

Also, the document D(Tid) is created by copying the document D-st. Note that it becomes easier to carry out the comparison for judging whether the nodes are equivalent or not in the access collision check, by carrying out a method for attaching a pointer from each node of the document D(Tid) to each corresponding node of the document D-st at a time of copying, for example.

The accesses of the transaction with the transaction identifier Tid thereafter will be made with respect to the document D(Tid).

(2) Processing Procedure when the Transaction Requested the Reading Access:

FIG. 12 shows an exemplary processing procedure when the transaction with the transaction identifier Tid requested the reading access READ(path).

In FIG. 12, Eval(document name #1, document name #2, reading access) indicates a function which returns the node sets resulting from the evaluation of the “path” of the reading access READ(path) with respect to the document specified by the document name #1 and the document specified by the document name #2. At a time of the evaluation of the “path”, the equivalency check of the node sets that are looked up is also carried out according to the need in the course of the search, and if they are not equivalent, the search is interrupted and a result “conflict” that notifies the access collision is returned. Otherwise, the search is continued to the end, and the node set of the result is returned. Namely, Eval is a function for obtaining the result of the reading access while carrying out the equivalency check for the node sets looked up by the reading accesses with respect to the document of the document name #1 and the document of the document name #2, as described above for the RW access collision check.

First, the result of Eval(D(Tid), D-all, READ(path)) is obtained (step S11). If the result is “conflict”, the RW access collision will occur. Otherwise, the RW access collision will not occur.

In the case where the RW access collision will not occur (step S12 NO), the result of the reading access is returned to the application program 5 through the transaction manager 11, and the processing is continued (step S13). Also, READ(path) is recorded in the transaction access sequence AS(Tid) (step S14).

In the case where the RW access collision will occur (step S12 YES), the writing access of which transaction will collide with the reading access is checked, and the finishing of that transaction have to be waited. In this check, the transaction identifier Tid′ for which Eval(D(Tid), D(Tid′), READ(path))=conflict is found from the transaction list 123 (step S15). Then, the reading access processing is interrupted and (Tid′→Tid) is added to the transaction waiting graph 122 (step S16). The transaction with the transaction identifier Tid is kept waiting until the processing of the transaction with the transaction identifier Tid′ is finished.

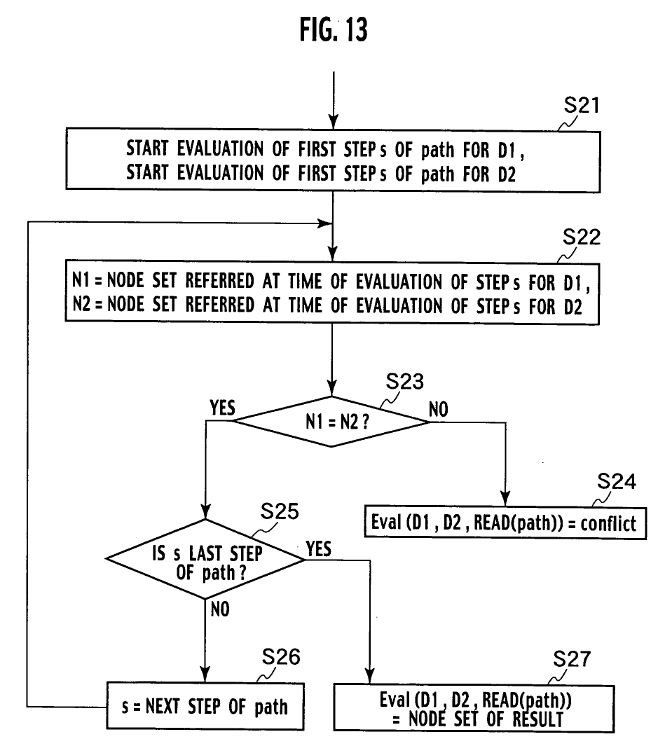

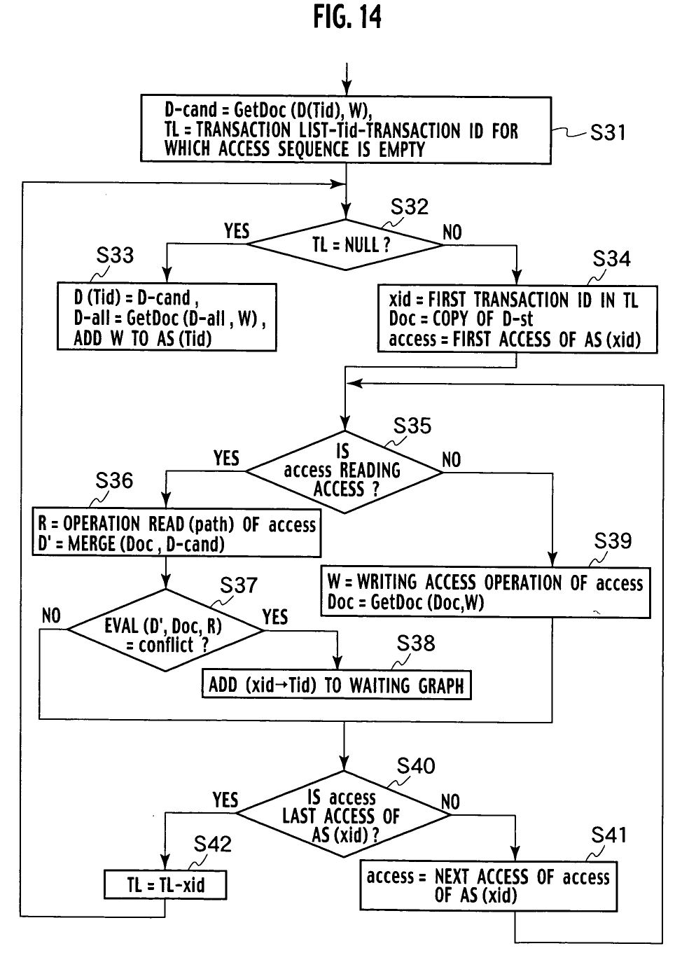

FIG. 13 shows an exemplary processing procedure of the function Eval.

First, the evaluation of the first step s of the “path” with respect to the document D1 is started, and the evaluation of the first step s of the “path” with respect to the document D2 is started (step S21).

Then, the node set looked up at a time of the evaluation of the step s with respect to the document D1 is set as N1, and the node set looked up at a time of the evaluation of the step s with respect to the document D2 is set as N2 (step S22).

Here, if the node set N1 and the node set N2 are not equivalent (step S23 NO), Eval(D1, D2, READ(path))=conflict is returned and the processing is finished (step S24).

If the node set N1 and the node set N2 are equivalent (step S23 YES), unless the step s is the last step of the “path” (step S25 NO), s is set to be the next step of the “path” (step S26), and the processing from the step S22 is repeated, whereas when the step s is the last step of the “path” (step S25 YES), Eval(D1, D2, READ(path))=the node set of the result is returned and the processing is finished (step S27).

(3) Processing Procedure when the Transaction Requested the Writing Access:

FIG. 14 shows an exemplary processing procedure when the transaction with the transaction identifier Tid requested the writing access.

In FIG. 14, MERGE(document name #1, document name #2) indicates a function for returning the document resulting from merging the document specified by the document name #1 and the document specified by the document name #2.

Also, in FIG. 14, GetDoc(document name, writing access) indicates a function for returning the document in which the update result of the operation specified by the writing access is reflected on the document specified by the document name.

First, for the sake of the WR access collision check, the requested writing access W is made with respect to the document D(Tid) and the document D-cand=GetDoc(D(Tid), W) that reflects the update result is obtained (step S31). The writing access W is any one of the operations of Insert(node, data), INSERT(node, child-data), DELETE(node), and REPLACE(node, data). Also, TL is set such that TL=transaction list−Tid−transaction identifier for which the transaction access sequence is empty (step S32).

Then, the processing of the steps S34 to S40 is carried out with respect to the individual transaction for which the transaction access sequence is not empty among the other transactions in the transaction list.

If TL≠NULL (step S32 NO), the transaction identifier of the first transaction in the TL is set as xid, the document Doc is prepared by copying the document D-st for the transaction with the transaction identifier xid, and the first access record in the transaction access sequence AS(xid) is taken out and set as “access” (step S34).

If the “access” is the reading access (step S35 YES), R is set such that R=the operation READ(path) of “access”, D′ is set as D′=MERGE(Doc, D-cand), and Eval(D′, Doc, R) is obtained (step S36).

If the result of Eval(D′, Doc, R) is conflict (step S37 YES), the WR access collision will occur so that the processing of the writing access is interrupted, (xid→Tid) is added to the transaction waiting graph 122, and the processing is finished (step S38). The transaction with the transaction identifier Tid is kept waiting until the processing of the transaction with the transaction identifier xid is finished.

If the result of Eval(D′, Doc, R) is not conflict (step S37 NO), the WR access collision will not occur so that the processing proceeds to the step S40.

On the other hand, if the “access” is the writing access at the step S35, Doc=GetDoc(Doc, W) is executed as the operation of the writing access of W=access, and the update made by the taken out writing access W is reflected on the document Doc (step S39), and the processing proceeds to the step S40.

Unless the “access” is the last access of the transaction access sequence AS(xid) (step S40 NO), the next access of the transaction access sequence AS(xid) is taken out and this is set as “access” (step S41), and the processing returns to the step S35.

If the “access” is the last access of the transaction access sequence AS(xid) (step S40 YES), the check of the collision with respect to the corresponding transaction is finished, the TL is set as TL=TL−xid (step S42), and the processing returns to the step S32.

Then, if TL=NULL at the step S32, that is, there is no collision throughout the WR access collision check with respect to all the target transaction, D(Tid) and D-all are set as D(Tid)=D-cand and D-all=GetDoc(D-all, W), the result of the writing access W is reflected on both the document D(Tid) and the document D-all, and the writing access W is recorded in the transaction access sequence AS(Tid) (step S33).

(4) Processing Procedure at a Time of Resuming the Transaction after the Interruption:

No special processing is required at a time of resuming the transaction after the interruption. In the case where the interrupted access is the reading access, the processing is returned to the beginning of the processing procedure when the transaction requested the reading access of the above described (2) and the processing is continued. In the case where the interrupted access is the writing access, the processing is returned to the beginning of the processing procedure when the transaction requested the writing access of the above described (3) and the processing is continued.

(5) Processing Procedure at a Time of Committing the Transaction:

At a time of finishing the transaction by committing it, the processing A for reflecting the update result of the data made by that transaction on the file and the documents of the other transactions, and the processing B for resuming the other transactions that are interrupted and kept waiting for the finishing of that transaction are carried out.

In the case of committing the transaction with the transaction identifier Tid, as the processing A, the document D(Tid) is merged with the document D-st of the file at that timing, and recorded in the file 31 on the hard disk 3. Also, the document D(Tid) is merged with the document D corresponding to each transaction recorded in the transaction list 123. By this operation, the committed update result is reflected in the documents D of all the transactions including those that are interrupted.

Here, the exemplary case where the committed update result is notified to the other transactions currently processed in parallel at a time of committing the transaction has been described, but it is also possible to omit this processing or carry it out later on. When this processing is omitted, the already committed update of the data is not reflected in the document D of the individual transaction but it exists. Consequently, when the RW access collision is detected in the processing procedure of the above described (2), if the target of the access collision is the already committed transaction, it suffices to reflect the committed update result on the document D of the transaction that caused the access collision at that timing.

Next, for the sake of the processing B, the transaction which is kept waiting for the finishing of the transaction with the transaction identifier Tid is found from the transaction waiting graph 122. If such a transaction exists, the resuming of that transaction is commanded. Also, the vertex indicating the transaction with the transaction identifier Tid and all the edges which have that vertex as the starting vertex are deleted from the transaction waiting graph 122.

When the processing A and the processing B are finished, finally the transaction identifier Tid is deleted from the transaction list 123 and the transaction waiting graph 122, and the transaction access sequence AS(Tid) and the document D(Tid) are also deleted.

(6) Processing Procedure at a Time of Aborting the Transaction:

At a time of finishing the transaction by aborting it, the update result of the data made by that transaction is discarded. The update results made by all the transaction currently processed are reflected on the document D-all, so that the update result made by the transaction to be aborted is also reflected. In order to discard that update result, the processing for re-creating the document D-all is carried out. Also, similarly as in the case of committing, the processing for resuming the other transactions that are kept waiting for the finishing of that transaction is carried out.

At a time of aborting the transaction with the transaction identifier Tid, the transaction identifier Tid is deleted from the transaction list 123 first, and the transaction access sequence AS(Tid) and the document D(Tid) are also deleted.

Then, the transaction which is kept waiting for the finishing of the transaction with the transaction identifier Tid is found from the transaction waiting graph 122. If such a transaction exists, the resuming of that transaction is commanded. Also, the vertex indicating the transaction with the transaction identifier Tid and all the edges which have that vertex as the starting vertex are deleted from the transaction waiting graph 122.

Finally, the documents D of all the transactions existing in the transaction list 123 are merged together with the document D-st of the file at that timing, such that the document D-all is re-created. By this processing, the document D-all will reflect the update results of all the processing that are currently processed except for the transaction that is to be aborted.

(Second Exemplary Configuration of the Resource Manager)

Next, the second exemplary configuration of the resource manager will be described.

The second exemplary configuration differs from the first exemplary configuration in the method for the WR access collision check. In the first exemplary configuration, the resource manager 12 carries out the WR access collision check while re-creating the state of the document D at a time of the earlier reading access by tracing the transaction access sequence of the transaction. In the second exemplary configuration, the resource manager 12 carries out the WR access collision check by the method using the earlier state of the document D-all, instead of the method for re-creating the earlier state of each document D.

(Check of the WR Access Collision)

In the following, the check of the WR access collision will be described.

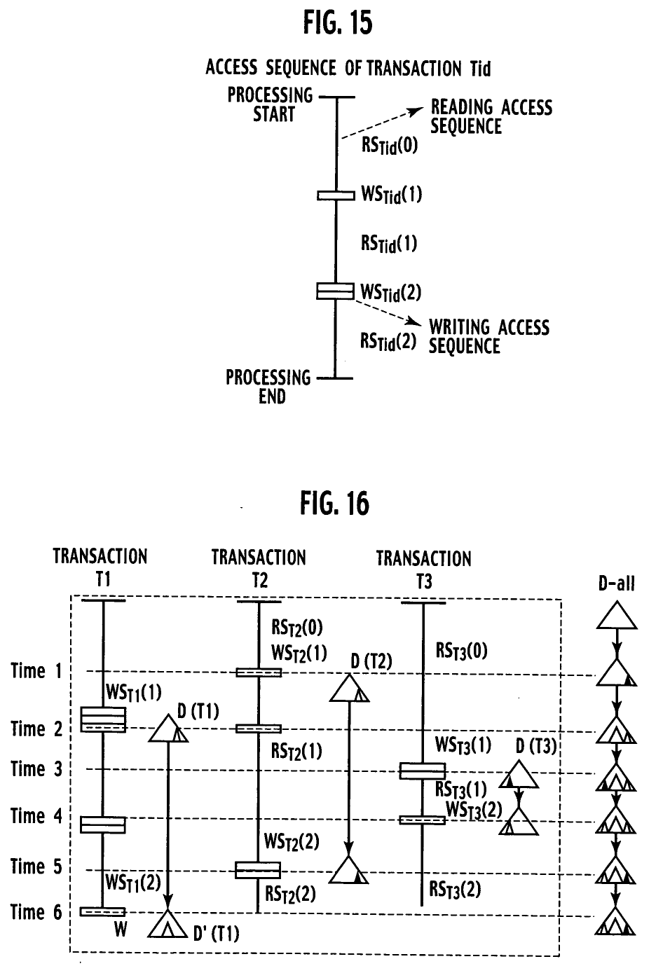

FIG. 15 shows an example of the transaction access sequence of one transaction with the transaction identifier Tid. The transaction has the transaction access sequence formed by the reading accesses and the writing accesses. In FIG. 15, a vertical line represents a continuous reading access sequence (including the case of a sequence formed by a single reading access alone), a rectangle represents the writing access, and vertically consecutive rectangles represent the continuous writing access sequence. Hereafter, the continuous reading access sequence and the continuous writing access sequence of the transaction with the transaction identifier Tid will be denoted as RS_{Tid} and WS_{Tid} respectively. Also, the i-th WS_{Tid} since the start of the transaction processing will be denoted as WS_{Tid} (i), and the RS_{Tid} that follows WS_{Tid}(i) will be denoted as RS_{Tid}(i). The reading access sequence before the first writing access will be denoted as RS_{Tid}(0).

Here, it is assumed that the resource manager 12 is processing three transactions T1, T2 and T3 which have the transaction access sequences as shown in FIG. 16, and the exemplary case of the WR access collision check when the transaction T1 requests the writing access W at a timing of Time6 will be described.

The resource manager 12 needs to check whether this writing access W collides with the reading accesses already made by the other transactions currently processed in parallel, i.e., the transaction T2 and the transaction T3. Namely, the target of the WR access collision check includes all the reading accesses of RS_{T2}(0), RS_{T2}(1) and RS_{T2}(2) of the transaction T2 and all the reading accesses of RS_{T3}(0), RS_{T3}(1) and RS_{T3}(2) of the transaction T3.

The document after the update by the writing access W made by the transaction T1 with respect to the document D(1) will be denoted as D′(1).

As described in the first exemplary configuration, when the WR access collision with the reading access R of RS_{T2}(1) is to be checked, for example, the node sets looked up by the reading accesses R with respect to the document D(2) at a timing of Time1 and the document obtained by merging the document D(2) and the document D′(1) are compared.

This check is to be carried out with respect to all the reading accesses, so that in the first exemplary configuration, the document D(2) at timings of Time1 and Time 5 and the document D83) at timings of Time3 and Time4 are obtained by sequentially executing the transaction access sequences of the transaction T1 and the transaction T2.

In contrast, in the second exemplary configuration, the WR access collision is checked by using the document D-all. The document D(2) at a timing of Time1 is obtained by reflecting the update result of the writing access W of WS_{T2}(1) with respect to the document D-st. This update is also reflected on the document D-all at a timing of Time1, so that the same result can be obtained by making the reading access R with respect to the document D-all at a timing of Time1, instead of using the document D(2) at a timing of Time1. Consequently, the access collision check becomes equivalent to comparing the node set looked up by the reading access R with respect to the document D-all at a timing of Time1 and the node set looked up by the reading access R with respect to the document obtained by merging the document D′(1) and the document D-all at a timing of Time1 to see if they are the same or not.

Similarly, in the check with respect to RS_{T2}(0) and RS_{T3}(0), the document D-all at an initial timing, i.e., the document D-st can be used, and in the check with respect to RS_{T2}(2), the document D-all at a timing of Time5 can be used, and the check with respect to RS_{T3}(1) and RS_{T3}(2), the document D-all at timings of Time3 and Time4 can be used. In the second exemplary configuration, each state of the document D-all that is updated is recorded, and used in the subsequent WR access collision check.

In the case where the sufficient recording capacity can be secured, the state of the document D-all at every timing can be recorded, but in the case where the recording capacity is limited, it is not possible to record the state of the document D-all at every timing, so that there is a need to determine the timings at which the state of the document D-all is to be recorded most effectively.

For example, at a time of carrying out the check of the collision with respect to the reading access of RS_{T2}(1), either the document D-all at a timing of Time1 or the document D-all at timings of Time3 and Time4 can be used. This is because the node sets looked up by the reading access R with respect to the document D-all at any timings between Time1 at which the update by WS_{T2}(1) of the transaction T2 is reflected on the document D-all and Time5 at which the next update by WS_{T2}(2) of the transaction T2 is reflected on the document D-all are equivalent. The document D-all reflects the update results of all the transactions processed in parallel by the resource manager 12, and these updates do not cause the access collision with each other.

If the node set looked up by the reading access R with respect to the document D-all at a timing of Time1 and the node set looked up by the reading access R with respect to the document D-all at a timing of Time2 are different, it implies that the writing access of the transaction T1 that updated the document D-all at a timing of Time2 will collides with the reading access R. However, the update of the document D-all at Time5 is made by the writing access of the transaction T2, not of the other transaction, so that the node set looked up by the reading access R of the transaction T2 with respect to the document D-all at Time5 is not the same as the earlier result.

For these reasons, in this example, the document D-all at a timing of Time3 can be used in the WR access collision check with respect to RS_{T2}(1) and RS_{T3}(1). In the second exemplary configuration, the state of the document D-all that can be utilized in the WR access collision check with respect to a plurality of RS such as the document D-all at a timing of Time3 is selectively recorded. The method for determining the timings at which the state of the document D-all is to be recorded will be described in detail below.

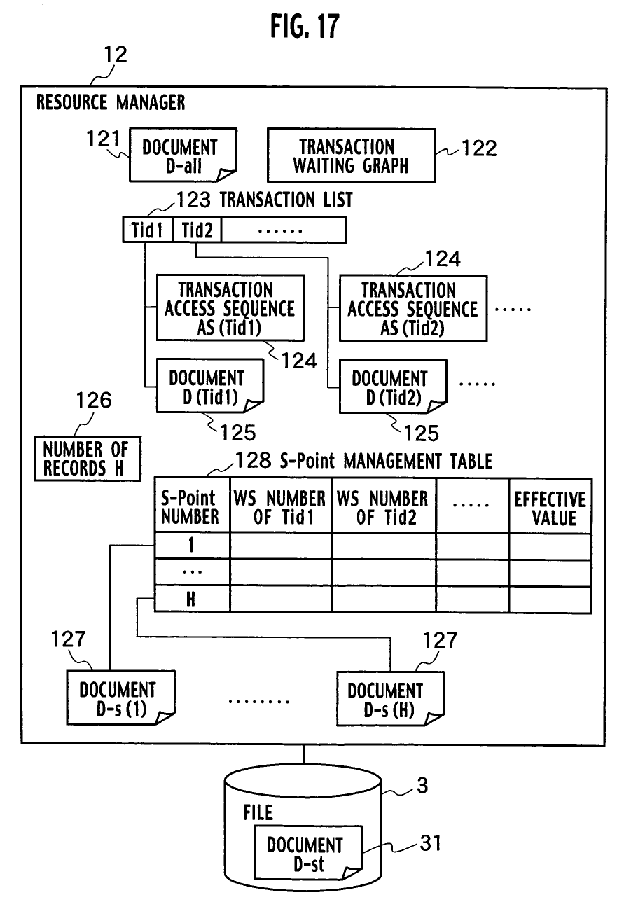

FIG. 17 shows the second exemplary configuration of the resource manager 12, which has a document D-all 121, a transaction waiting graph 122, a transaction list 123, transaction access sequences 124, documents D(Tid) 125, a number of records H 126, documents D-s 127, and an S-Point management table 128, with respect to the document D-st 31 stored in the hard disk 3.

In the following, the differences from the resource manager 12 in the first exemplary configuration will be mainly described.

The transaction access sequence 124 of FIG. 17 records and manages a sequence of the reading accesses and the writing accesses made by the individual transaction since the start of its processing, as a list, similarly as in the resource manager 12 in the first exemplary configuration. Here, however, the number of writing accesses in the writing access sequence is also managed in addition to the reading accesses and the writing accesses. As will be described below, the number of writing accesses will be used in determining the timings at which the state of the document D-all is to be recorded.

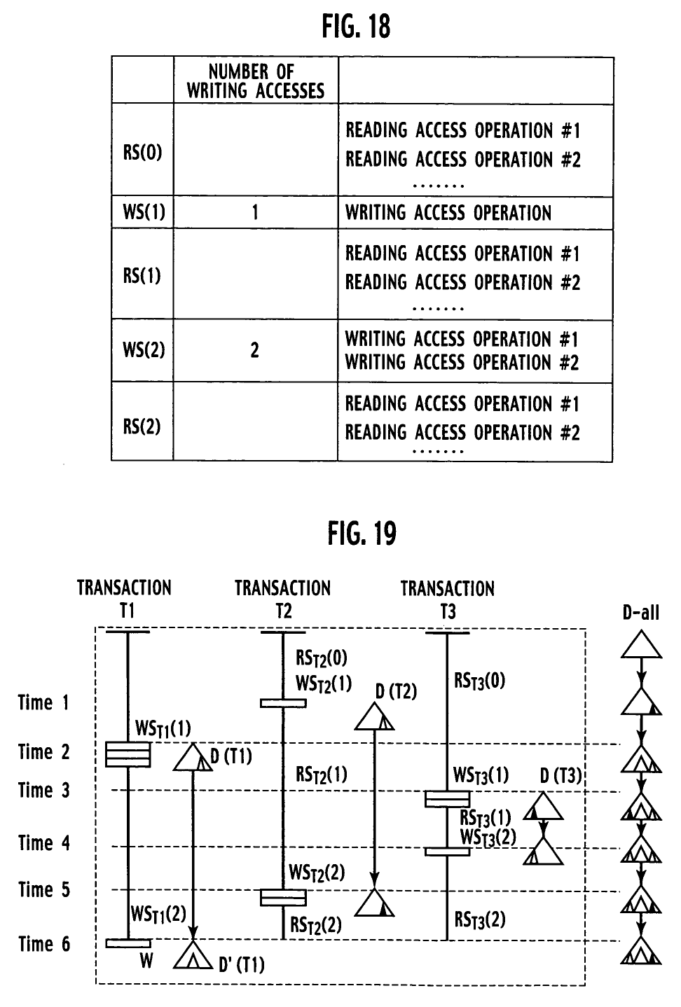

FIG. 18 shows an exemplary configuration of the transaction access sequence. This is the transaction access sequence for the same example as the transaction access sequence of the transaction with the transaction identifier Tid shown in FIG. 15.

The transaction access sequence AS(Tid) is a list of the reading access sequence and the writing access sequence, in which a list of the reading access operations of the i-th reading access sequence RS_{Tid}(i) and a list of the writing access operations of the i-th writing access sequence WS_{Tid}(i) of the transaction with the transaction identifier Tid are respectively recorded in RS(i) and WS(i).

The number of records H 126 of FIG. 17 is a numerical value indicating how many states before the update of the document D-all can be recorded. When the number of records H is larger, the efficiency of the WR access collision check becomes higher because more number of states of the document D-all can be recorded. On the other hand, there is a trade off in that the memory capacity required for recording the states of the document D-all becomes larger. The number of records H is initially set by the transaction processing system, but its value may be changed during the transaction processing.

The document D-s 127 of FIG. 17 records the state of the document D-all at some timing in the past. In the following, the timing at which the state of the document D-all is recorded will be referred to as an S-Point, and determining to record the state of the document D-all at some timing will be referred to as setting the S-Point. The resource manager 12 can set as many S-Points as the number of records H, so that it is recording and managing up to H sets of documents D-s. The document D-s that is recorded at the i-th S-Point will be denoted as D-s(i).

The S-Point management table 128 of FIG. 17 has up to H sets of entries, and each entry corresponds to individual S-Point. In each entry, information indicating the order of the writing access sequence WS among all the writing access sequences up to which the update results are reflected on the document D-all by each transaction at a timing at which the corresponding S-Point is set and information indicating a size of the effect obtained by the setting of that S-Point are recorded and managed.

In the following, the method by which the resource manager 12 determines to set the S-Point by utilizing information recorded in the S-Point management table 128 will be described.

FIG. 19 shows the same three transaction access sequence of the transactions T1, T2 and T3 as those shown in FIG. 16, which is an example in which timings between Time1 and Time5 are different from FIG. 16.

When each writing access requested by the transaction is judged as not breaking the isolation and the document D-all is to be updated, whether the S-Point should be set or not, that is whether the state of the document D-all at that timing should be recorded as the document D-s or not, is determined.

FIG. 20 shows the S-Point management table 128 when the first S-Point is set at a timing of Time1 in FIG. 19 and the second S-Point is set at a timing of Time2 in FIG. 19.

Each entry of the S-Point management table 128 corresponds to one S-Point, and the S-Point number of each entry indicates the order of the corresponding S-Point among all the S-Points.

The S-Point entry has a field for the WS number corresponding to each transaction currently processed by the resource manager 12. In the field of the WS number for each transaction, the order of the latest writing access sequence WS among all the writing access sequences of that transaction at a timing at which the S-Point is set is recorded. From the WS number of each transaction in the S-Point entry, the order of the writing access sequence WS among all the writing access sequences of that transaction up to which the update results are reflected on the document D-all recorded at a timing of the S-Point (that is, document D-s) can be ascertained. Consequently, it can be seen that, by utilizing the document D-s corresponding to the S-Point, the WR access collision check with respect to the reading access of the (WS number)-th reading access sequence of that transaction can be carried out.

For example, in FIG. 19, the latest writing access sequence WS_{T2}(1) of the transaction T2 at a timing of Time1 at which the first S-Point is set is the first WS. Consequently, in FIG. 20, the WS number of the transaction T2 in the entry with the S-Point number “1” is “1”. For the other transactions T1 and T3, there is no latest writing access sequence so that the WS number is “0”. Similarly, the latest writing access sequence WS_{T1}(1) of the transaction T1 at a timing of Time2 at which the second S-Point is set is the first WS, so that the WS number of the transaction T1 in the entry with the S-Point number “2” is “1” in FIG. 20.

The S-Point entry has a field for the effective value that indicates a size of the effect obtained by setting the corresponding S-Point. When the S-Point is set and the state of the document D-all is recorded as the document D-s, the document D-s can be utilized in the subsequent WR access collision check, so that the cost required for reproducing the state of the document D-all can be reduced. This cost can be reduced at each occasion of the WR access collision check after setting the S-Point, so that the size of the effect obtained by setting the S-Point is proportional to the cost that would be required for reproducing the document D-all at that timing if the S-Point is not set. In order to reproduce the document D-all at a timing of the S-Point, there is a need to reproduce the updates reflected on the document D-all by making the writing accesses of the latest writing access sequence of each transaction at that timing (that is, the (WS number)-th writing access sequence).

Consequently, the effective value of the S-Point is defined as a sum of the number of writing accesses in the (WS number)-th writing access sequence of each transaction in the S-Point entry.

However, in the case where the WS number of the transaction in the S-Point entry is the same as the WS number in an immediately previous S-Point entry, the update result of the (WS number)-th writing access sequence is already reflected in the document D-s of the immediately previous S-Point, so that the number of writing accesses of the (WS number)-th writing access sequence of that transaction is not added to the sum.

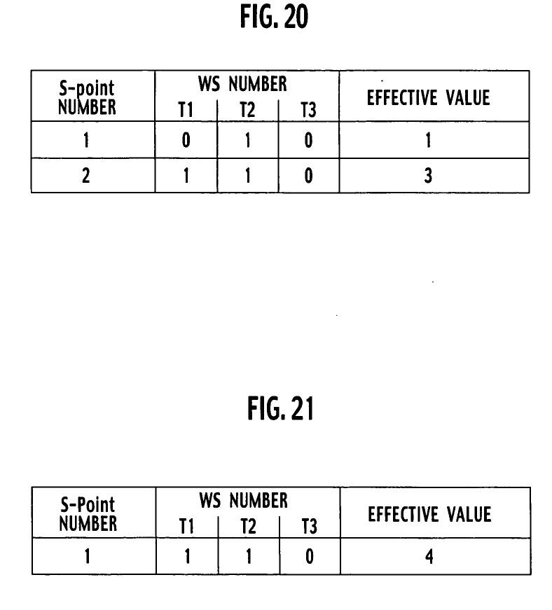

For example, the effective value of the first S-Point in FIG. 20 is “1” according to the number of writing accesses of WS_{T2}(1), and the effective value of the second S-Point in FIG. 20 is “3” according to the number of writing accesses of WS_{T1}(1). The WS number of the transaction T2 in the second S-Point entry is “1”, but the WS number of the immediately previous first S-Point entry is also the same “1”, so that the number of writing accesses of WS_{T2}(1) is not added to the effective value of the second S-Point. For example, if the first S-Point is set at Time2 in FIG. 19, the S-Point management table 128 becomes as shown in FIG. 21, and the effective value of the first S-Point becomes the number of writing accesses of WS_{T1}(1) plus the number of writing accesses of WS_{T2} (1), i.e., 3+1=4.

The resource manager 12 can learn which document D-s can be utilized at a time of the WR access collision check by looking up the WS number of each transaction in the S-Point management table 128. Also, the resource manager 12 calculates the effective value resulting when the S-Point is set at some timing, and determines whether a new S-Point should be set or not according to that value. The method for determining the S-Point setting will be described in detail below as a part of the processing procedure of the resource manager 12 when the transaction requested the writing access.

In the following, the processing procedure to be carried out by the resource manager 12 in this second exemplary configuration will be described in an order of (1) the processing procedure at a time of starting the processing of the transaction, (2) the processing procedure when the transaction requested the reading access, (3) the processing procedure when the transaction requested the writing access, (4) the processing procedure at a time of resuming the transaction after the interruption, (5) the processing procedure at a time of committing the transaction, and (6) the processing procedure at a time of aborting the transaction.

(1) Processing Procedure at a Time of Starting the Processing of the Transaction:

The exemplary processing procedure at a time of starting the processing of the transaction is the same as the exemplary processing procedure of the resource manager 12 in the first exemplary configuration shown in FIG. 11.

(2) Processing Procedure when the Transaction Requested the Reading Access:

The exemplary processing procedure when the transaction requested the reading access is the similar to the exemplary processing procedure of the resource manager 12 in the first exemplary configuration shown in FIG. 12. However, when READ(path) is added to the transaction access sequence AS(Tid) at the step S14 of FIG. 12, if the last access sequence of AS(Tid) is the reading access sequence RS(i), it is recorded at the end of the list, and if the last access sequence of AS(Tid) is the writing access sequence WS(i), a new RS(i) is created and it is recorded as its first access. In the case of the first access of the transaction, it is recorded as the first access of RS(0).

(3) Processing Procedure when the Transaction Requested the Writing Access:

The resource manager 12 first checks the S-Point management table 128, and carries out the WR access collision check while looking up the utilizable document D-s. If it is ascertained that the requested writing access does not cause the collision as a result of the check, the resource manager 12 next determines whether the S-Point should be set at that timing or not, and then reflects the result of the writing access on the document D-all.

In the following, the WS number corresponding to each transaction with the transaction identifier Tid in the h-th S-Point entry of the S-Point management table 128 will be denoted as M_{Tid}(h).

First, the check of the WR access collision will be described.

The resource manager 12 needs to check if the writing access W requested by the transaction with the transaction identifier Tid causes the collision with the reading access sequences of all the other transactions in the transaction list. When the checking target reading access sequence number is written in the WS number field of the entry of the S-Point management table 128, the document D-s of the corresponding S-Point will be utilized. If that number is not written, there is a need to re-create the document D-all at that timing. However, at a time of carrying out the check with respect to the first reading access sequence RS(0) of each transaction, the document D-st can be utilized, and at a time of carrying out the check with respect to the latest reading access sequence, the document D-all can be utilized. The document D-all at the current timing reflects the result of the latest writing of each transaction, that is, the result of the writing by the last WS in the transaction access sequence.

In the WR access collision check, the document D-cand is prepared first by reflecting the writing access W requested by the transaction with the transaction identifier Tid on the document D(Tid). Also, the initial value of a variable h is set to be the last S-Point number+1.

Here, the exemplary case of carrying out the collision check by looking up the S-Point management table 128 in a reverse order from the last entry to the first entry will be described, but it is also possible to use any other order.

The processing when the variable h is the last S-Point number+1 is the check with respect to the latest reading access sequence RS of each transaction. When the last writing access sequence of each transaction at that timing is WS(i), it is the check with respect to RS(i). As already described above, in this case, the document D-all at that timing can be utilized so that if the result of Eval(D-all, MERGE(D-all, D-cand), R) is “conflict” or not is checked for each reading access R of RS(i). When the result is not “conflict” for each reading access of all the transactions, the collision will not occur.

The processing when the variable h is 0 is the check with respect to the first reading access sequence RS(0) of each transaction. As already described above, in this case, the document D-st can be utilized so that if the result of Eval(D-st, MERGE(D-st, D-cand), R) is “conflict” or not is checked for each reading access R of RS(0). When the result is not “conflict” for each reading access of all the transactions, the collision will not occur.

When the variable h takes any other value, the following processing is carried out with respect to each transaction. The transaction identifier is assumed to be xid. The WS number M_{xid}(h) of the transaction with the transaction identifier xid is checked from the h-th entry of the S-Point management table 128, and set that WS number as i. Note that the document D-s(h) recorded at a timing at which the h-th S-Point is set reflects the update result of WS(i), so that the document D-s(h) can be utilized in the access collision check with respect to RS(i). If i=M_{xid}(h+1), the check with respect to RS(i) was already carried out so that there is no need to check.

Otherwise, first Eval(D-s(h), MERGE(D-s(h), D-cand), R) is checked for each reading access R of RS(i). Next, i is set to be i=i+1, and the next reading access sequence of RS(i) is considered. If i=M_{xid}(h+1), the check with respect to RS(i) was already carried out. If i<M_{xid}(h+1), the state of the document D-all at a timing at which the reading access of RS(i) was made is not recorded, so that there is a need to re-create it. The document obtained by carrying out the update operation of WS(i) on the document D-s(h) is set as Doc, and the check with respect to RS(i) is carried out by using Doc. Namely, the result of Eval(Doc, MERGE(Doc, D-cand), R) is checked with respect to each reading access R of RS(i). This processing is repeated until the condition that the next reading access sequence of RS(i) is the last RS or the check with respect to that RS was already carried out is satisfied.

In this way, the WR access collision check with respect to the reading access sequences of all the transactions is completed and there is no collision, the processing procedure proceeds to the processing for determining whether the S-Point should be set at that timing or not.

After that, the result of the writing access W is reflected on both the document D(Tid) and the document D-all. Also, the writing access W is recorded in the transaction access sequence AS(Tid).

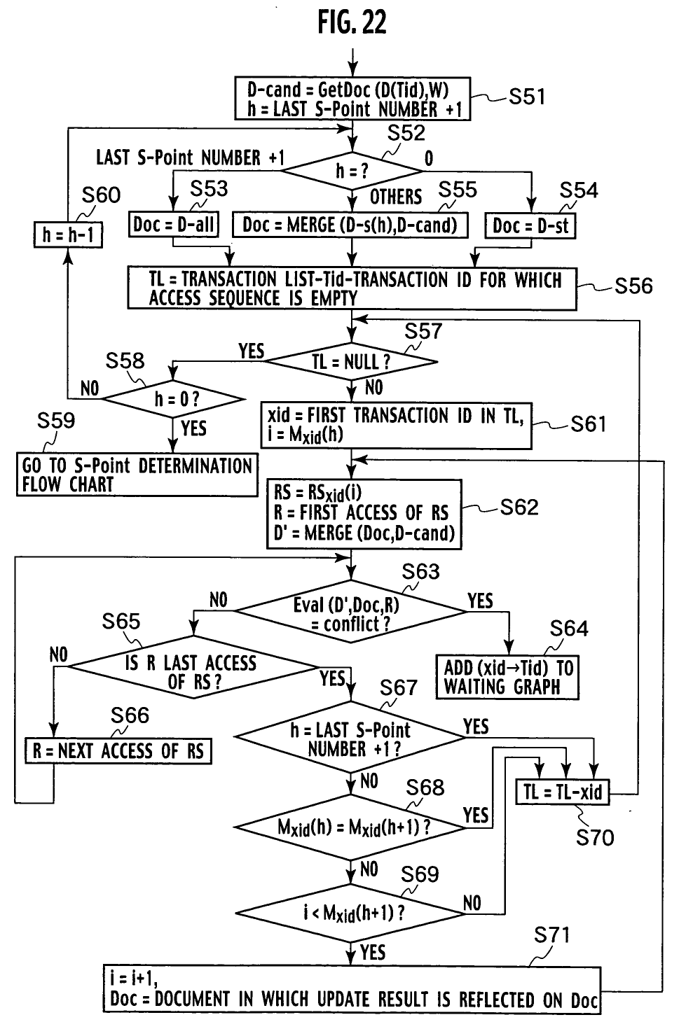

FIG. 22 shows an exemplary processing procedure for the WR access collision check when the transaction with the transaction identifier Tid requested the writing access W.

At the step S51, it is set that D-cand=GetDoc(D(Tid), W), and h=the last S-Point number+1.

At the step S52, if h=the last S-Point number+1, it is set that Doc=D-all at the step S53, if h=0, it is set that Doc=D-st at the step S54, and if h is any other value, it is set that Doc=MERGE(D-s(h), D-cand) at the step S55. Then, in either case, it is set that TL=transaction list−Tid−transaction identifier for which the access sequence is empty at the step S56.

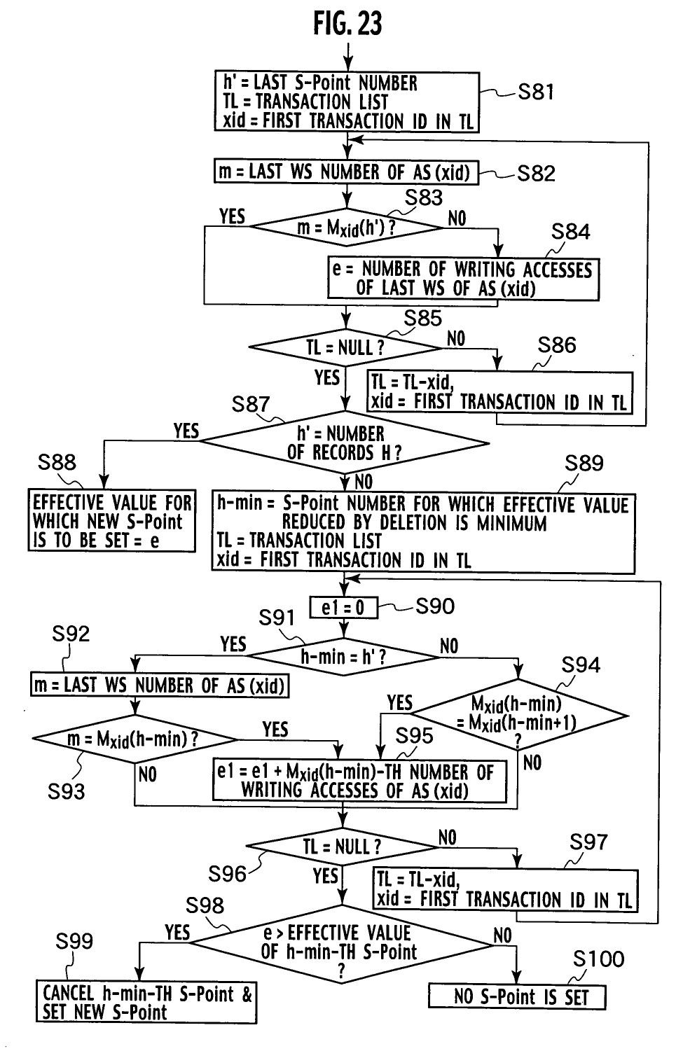

If TL=NULL at the step S57 and if h=0 at the step S58, the processing proceeds to the step S59 where this processing is finished and the next S-Point determination flow chart of FIG. 23 is executed. On the other hand if h≠0 at the step S58, it is set that h=h−1 at the step S60, and the processing returns to the step S52.

If TL≠NULL at the step S57, it is set that xid=first transaction identifier in TL and i=M_{xid}(h) at the step S61, and it is set that RS=R_{xid}(i), R=first access of RS, and D′=MERGE(Doc, D-cand) at the step S62.

If Eval(D′, Doc, R)=conflict at the step S63, (xid→Tid) is added to the transaction waiting graph 122 at the step S64.

On the other hand, if Eval(D′, Doc, R)≠conflict at the step S63, and when R is not the last access of RS at the step S65, it is set that R=next access of RS at the step S66, and the processing returns to the step S63.

When R is the last access of RS at the step S65, if h=last S-Point number+1 at the step S67, or not so at the step S67 but it is M_{xid}(h)=M_{xid}(h+1) at the step S68, or not so at the step S68 but it is not i<M_{xid}(h+1) at the step S69, it is set that TL=TL−xid at the step S70, and the processing returns to the step S62.

Also, when it is i<M_{xid}(h+1) at the step S69, it is set that i=i+1 and Doc=document in which the update result of WS(i) is reflected on Doc at the step S71, and the processing returns to the step S62.

Next, the processing for setting of the S-Point will be described.

This processing is carried out before recording the writing access W as the first access of the new writing access sequence WS(i+1) of the transaction access sequence.

First, the effective value that will be increased when the new S-Point is set is calculated. As already described above, the effective value is a sum of the number of writing accesses of the latest writing access sequence WS in all the transactions. However, if the WS number is the same as the WS number in the immediately previous S-Point entry, the number of writing accesses of WS is not added to the effective value. In FIG. 23, the variable e represents the calculated effective value.

After calculating the effective value (e), the last S-Point number in the S-Point management table 128 is checked. The last S-Point number indicates the number of S-Points that are set by or before that timing. This number is set as h′.

If h′ is smaller than the number of records H, a new S-Point is set by newly creating an entry for the h′+1-th S-Point in the S-Point management table 128. The S-Point number of the entry is h′+1, and the effective value is e. In the WS number corresponding to each transaction, the number of writing accesses in the latest writing access sequence of each transaction is recorded by checking the transaction access sequence. Then, the document D-all at that timing is recorded as D-s(h′+1).

If h′ is the same as the number of records H, it is not possible to set more S-Point in excess of that number. Consequently, the S-Point whose cancellation would cause the minimum reduction in the effective value is checked among all the already set S-Point, and its effective value is compared with the effective value that would be increased by setting a new S-Point. The effective value that would be reduced by the cancellation of each S-Point is the effective value of that S-Point minus a value that would be only shifted to the next S-Point (the newly set S-Point in the case of the latest S-Point) even if that S-Point is cancelled.

For example, the effective value of some h-th S-Point contains the number of writing accesses N of the (WS number)-th writing access sequence of some transaction with the transaction identifier xid will be considered. In the case where the transaction with the transaction identifier xid has the same WS number at the h+1-th S-Point (a new S-Point in the case where h=h′), even when the h-th S-Point is cancelled, N is added to the effective value of the next h+1-th S-Point (or the new S-Point). Otherwise, as much as N of the effective value would be reduced by the cancellation of the h-th S-Point.

The S-Point number of the S-Point whose cancellation would cause the minimum reduction in the effective value is set as h-min. The effective value that would be reduced by cancelling the h-min-th S-Point and the effective value that would be increased by setting the new S-Point are compared, and if the latter is larger, the h-min-th S-Point is cancelled and the new S-Point is set. The effective value that would be reduced by the cancellation of the h-min-th S-Point is the effective value of the h-min-th S-Point minus a value of the variable e1.

The value of the variable e1 is obtained by adding the number of writing accesses of the (WS number)-th writing access sequence when the WS number M_{xid}(h-min) corresponding to the h-min-th S-Point and the WS number M_{xid}(h-min+1) corresponding to the next h-min+1-th S-Point are the same with respect to each transaction. When M_{xid}(h-min) and M_{xid}(h-min+1) are the same, the update result of the (WS number)-th writing access sequence of the transaction with the transaction identifier xid is reflected on the document D-s(h+1) of the h-min+1-th S-Point even if the h-min-th S-Point is cancelled, so that its effective value would not be reduced but rather added to the effective value of the h-min+1-th S-Point.

When the effective value e that would be increased by setting the new S-Point is greater than the effective value that would be reduced by cancelling the h-min-th S-Point, the entry of the h-min-th S-Point and the document D-s(h-min) are deleted, and each one of the D-s numbers corresponding to the subsequent S-Point numbers is reduced by one. Also, e1 is added to the effective value of the new h-min-th S-Point. Then, the entry of the new S-Point is created and the document D-all at that timing is recorded as D-s(H).

FIG. 23 shows an exemplary processing procedure for setting the S-Point.

At the step S81, it is set that h′=last S-Point number, TL=transaction list, and xid=first transaction identifier in TL.

At the step S82, it is set that m=last WS number of AS(xid).

If m≠M1_{xid}(h′) at the step S83, it is set that e=number of writing accesses of the last WS of AS(xid) at the step S84, and if m=M1_{xid}(h′) at the step S83, the step S84 is skipped.

If TL≠NULL at the step S85, it is set that TL=TL−xid, xid=first transaction identifier in TL at the step S86, and the processing returns to the step S82.

If TL=NULL at the step S85 and if h′<the number of records H at the step S87, the processing proceeds to the step S88 where the new S-Point is set and its effective value is set equal to e, and this processing is finished.

On the other hand, if it is not h′<the number of records H at the step S87, the processing proceeds to the step S89 where it is set that h-min=S-Point number for which the effective value reduced by deletion is minimum, TL=transaction list, and xid=first transaction identifier in TL.

At the step S90, it is set that e1=0. Then, if h-min=h′ at the step S91, it is set that m=last WS number of AS(xid) at the step S92, and if m=M_{xid}(h-min) at the step S93, it is set that e1=e1+M_{xid}(h-min)-th number of writing accesses of AS(xid) at the step S95, and if m≠M_{xid}(h-min) at the step S93, the step S95 is skipped and the processing proceeds to the step S96.

On the other hand, if h-min≠h′ at the step S91, and if M_{xid}(h-min)=M_{xid}(h-min+1) at the step S94, it is set that e1=e1+M_{xid}(h-min)-th number of writing accesses of AS(xid) at the step S95, and if M_{xid}(h-min)≠M_{xid}(h-min+1) at the step S94, the step S95 is skipped and the processing proceeds to the step S96.

If TL≠NULL at the step S96, it is set that TL=TL−xid and xid=first transaction identifier in TL at the step S97, and the processing returns to the step S82.

On the other hand, if TL=NULL at the step S96, and if e>effective value of the h-min-th S-Point−e1 at the step S98, the h-min-th S-Point is set at the step S99 and the processing is finished. Also, if it is not e>effective value of the h-min-th S-Point−e1 at the step S98, the processing is finished without setting the S-Point at the step S100.

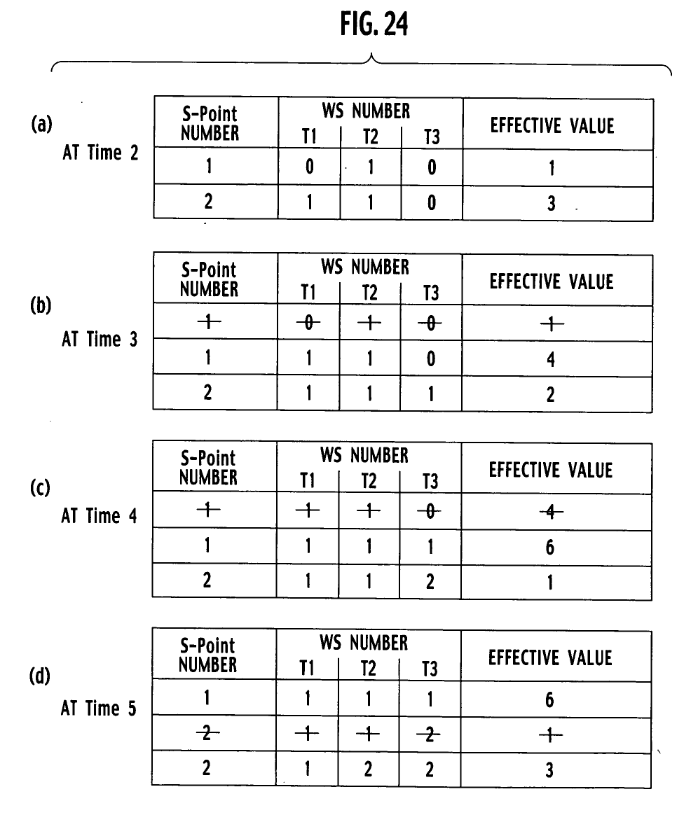

As an example, in the case where the number of records H=2, the change of the S-Point management table 128 at timings of Time2, Time3, Time4 and Time5 in FIG. 19 is shown in FIG. 24.

First, the S-Points at a timing of Time2 shown in a part (a) of FIG. 24 are the same as FIG. 20, as already described above.

Next, at a timing of Time3, the last S-Point number in the S-Point management table 128 is “2”, which is the same as the number of records H, so that whether a new S-Point should be set or not is judged. The effective value e that would be increased by setting the new S-Point is the number of writing accesses of WS_{T3}(1) of the transaction T3, which is “2”. If the first S-Point is deleted, the number of writing accesses of WS_{T2}(1) of the transaction T2 would be added to the effective value of the second S-Point, so that the effective value that would be reduced is “0” (the effective value that would be reduced by deleting the second S-Point similarly becomes “0”). Consequently, the first S-Point set at Time1 is cancelled and the new S-Point is set, such that the S-Point management table 128 becomes as shown in a part (b) of FIG. 24.

Next, at a timing of Time4, the effective value e that would be increased by setting the new S-Point is the number of writing accesses of WS_{T2}(2) of the transaction T2, which is “1”. If the first S-Point is deleted, the number of writing accesses of WS_{T1}(1) of the transaction T1+the number of writing accesses of WS_{T2}(1) of the transaction T2 (=4) would be added to the effective value of the second S-Point, so that the effective value that would be reduced is also “0” (the effective value that would be reduced by deleting the second S-Point similarly becomes “0”). Consequently, the first S-Point set at Time3 is cancelled and the new S-Point is set, such that the S-Point management table 128 becomes as shown in a part (c) of FIG. 24.

Finally, at a timing of Time5, the effective value e that would be increased by setting the new S-Point is the number of writing accesses of WS_{T2}(2) of the transaction T2, which is “2”. If the first S-Point is deleted, the effective value that would be reduced is the number of writing accesses of WS_{T3}(1) of the transaction T3 (=2). On the other hand, the effective value that would be reduced by deleting the second S-Point is “0”. Consequently, the second S-Point set at Time4 is cancelled and the new S-Point is set, such that the S-Point management table 128 becomes as shown in a part (d) of FIG. 24.

(4) The Processing Procedure at a Time of Resuming the Transaction After the Interruption:

The processing procedure at a time of resuming the transaction after the interruption is the same as the processing procedure of the resource manager 12 in the first exemplary configuration.

(5) Processing Procedure at a Time of Committing the Transaction:

At a time of finishing the transaction with the transaction identifier Tid by committing it, the processing for merging the document D(Tid) with the document D-st and the documents D of the other transactions in order to reflect the update result of the data made by that transaction on the file and the documents of the other transactions, and the processing for resuming the other transactions that are interrupted and kept waiting for the finishing of that transaction are carried out by checking the transaction waiting graph 122 are carried out, similarly as in the processing procedure of the resource manager 12 in the first exemplary configuration. Also, the transaction identifier Tid is deleted from the transaction list 123 and the transaction waiting graph 122, and the transaction access sequence AS(Tid) and the document D(Tid) are also deleted.

Besides these, the WS number field of the transaction with the transaction identifier Tid is also deleted from the S-Point management table 128, and the change of the effective value due to this deletion is made, by subtracting the number of writing accesses of the (WS number)-th writing access sequence of the transaction with the transaction identifier Tid that has been added to the effective value at each S-Point entry.

(6) Processing Procedure at a Time of Aborting the Transaction:

At a time of finishing the transaction with the transaction identifier Tid by aborting it, the processing for re-creating the document D-all in order to discard the update result of the data made by that transaction, and the processing for resuming the other transactions that are kept waiting for the finishing of that transaction are carried out by checking the transaction waiting graph 122, similarly as in the processing procedure of the resource manager 12 in the first exemplary configuration. Also, the transaction identifier Tid is deleted from the transaction list 123 and the transaction waiting graph 122, and the transaction access sequence AS(Tid) and the document D(Tid) are also deleted. The re-creation of the document D-all is carried out by merging the documents D of all the transactions existing in the transaction list 123 with the document D-st.

Besides these, similarly as in the case of committing the transaction, the WS number field of the transaction with the transaction identifier Tid is also deleted from the S-Point management table 128, and the change of the effective value due to this deletion is made. The S-Point management table 128 is used for recording and managing the states of the document D-all with higher effective values, so that it is also possible to determine the schedule for the optimum S-Point setting and carry out the re-creation of the document D-all according to that schedule at a time of the aborting.

As described, according to the present invention, it becomes possible to provide a transaction processing system and a concurrency control method capable of guaranteeing the isolation of transactions or controlling the order of processing such that the execution of transactions becomes serializable, even in the case where a plurality of transactions make accesses to the hierarchical data in parallel.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the transaction processing system of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A concurrency control method in a transaction processing system for processing a plurality of transactions in parallel with respect to hierarchical data, the concurrency control method comprising:
producing a copy of the hierarchical data at a time of starting an access to the hierarchical data by each transaction;
judging whether a collision between one of reading access or writing access to be made by a first transaction with respect to a copy of the hierarchical data for the first transaction and another one of reading access or writing access made by the second transaction with respect to a copy of the hierarchical data for the second transaction will occur or not;
carrying out a processing for avoiding the collision when the judging step judges that the collision will occur; and
reflecting a writing access made by the first transaction with respect to a copy of the hierarchical data for the first transaction, on the hierarchical data, when the first transaction is to be finished normally, and reflecting the writing access also on a copy of the hierarchical data for the second transaction if the second transaction is not finished yet.

2. The concurrency control method of claim 1, wherein the judging step judges whether the collision will occur or not, according to whether data looked up by making the reading access without taking the writing access into consideration and data looked up by making the reading access by taking the writing access into consideration are identical or not.

3. The concurrency control method of claim 1, wherein when the first transaction is to make the reading access with respect to a copy of the hierarchical data, the judging step judges whether the collision will occur or not according to whether first data looked up by making the reading access with respect to a copy of the hierarchical data for the first transaction and second data looked up by making the reading access with respect to data obtained by merging a copy of the hierarchical data for the first transaction and a copy of the hierarchical data for the second transaction are identical or not.

4. The concurrency control method of claim 3, wherein the judging step judges that the collision will not occur when the first data and the second data are judged as identical for all transactions that can be the second transaction, and judges that the collision will occur otherwise.

5. The concurrency control method of claim 1, further comprising:
making the writing access with respect to a shared copy produced by copying the hierarchical data in order to reflect writing accesses made by all transactions that make accesses to the hierarchical data, when the first transaction is to make the writing access with respect to a copy of the hierarchical data;
wherein when the first transaction is to make the reading access with respect to a copy of the hierarchical data, the judging step judges whether the collision will occur or not according to whether first data looked up by making the reading access and second data looked up by making the reading access with respect to the shared copy of the hierarchical data are identical or not.

6. The concurrency control method of claim 5, wherein the judging step judges that the collision will not occur when the first data and the second data are judged as identical, and judges that the collision will occur when the first data and the second data are judged as not identical.

7. The concurrency control method of claim 5, wherein when there is an upper limit to a number of shared copies that can be recorded, those shared copies which have a higher possibility of being utilized at a time of reproducing a state in which the reading access is to be made later on are recorded at a higher priority, among the shared copies corresponding to states at times of the writing accesses with respect to the hierarchical data.

8. The concurrency control method of claim 1, wherein when the first transaction is to make the writing access with respect to a copy of the hierarchical data, the judging step judges whether the collision will occur or not according to whether first data looked up by making the reading access of the second transaction and second data looked up by making the reading access of the second transaction with respect to a state of the hierarchical data after the writing access are identical or not, for all reading accesses by all transactions that make accesses to the hierarchical data and that can be the second transaction.

9. The concurrency control method of claim 8, wherein the judging step judges that the collision will not occur when the first data and the second data are judged as identical for all reading accesses of all transactions that make accesses to the hierarchical data and that can be the second transaction, and judges that the collision will occur otherwise.

10. The concurrency control method of claim 8, further comprising:
recording an access sequence of accesses made with respect to a copy of the hierarchical data by each transaction, for each one of all transactions that make accesses to the hierarchical data;
wherein the judging step obtains all reading accesses of all transactions that make accesses to the hierarchical data and that can be the second transaction, by looking up a record of the access sequence.

11. The concurrency control method of claim 8, further comprising:
recording data looked up by making the reading accesses;
wherein the judging step obtains the first data by looking up a record of the data looked up.

12. The concurrency control method of claim 8, wherein the judging step obtains the first data as data obtained by making the writing access that was made by the second transaction before the reading access, with respect to a state of the hierarchical data at a start of the second transaction, and then making the reading access with respect to a state of the hierarchical data after the writing access.

13. The concurrency control method of claim 8, further comprising:
making the writing access with respect to a shared copy produced by copying the hierarchical data in order to reflect writing accesses made by all transactions that make accesses to the hierarchical data, when the first transaction is to make the writing access with respect to a copy of the hierarchical data; and
storing states of the shared copy at timings at which the writing accesses were made by some of the transactions that make accesses to the hierarchical data;
wherein the judging step obtains the first data as data obtained by reproducing a state of the hierarchical data at a timing at which the reading access was made by selecting one of stored states of the shared copy which is close to the state of the hierarchical data at a timing at which the reading access was made and making the writing access that was made by the second transaction with respect to a selected state of the shared copy according to need, and then making the reading access with respect to a reproduced state of the hierarchical data.

14. The concurrency control method of claim 13, wherein when there is an upper limit to a number of shared copies that can be recorded, those shared copies which have a higher possibility of being utilized at a time of reproducing a state in which the reading access is to be made later on are recorded at a higher priority, among the shared copies corresponding to states at times of the writing accesses with respect to the hierarchical data.

15. The concurrency control method of claim 8, wherein the judging step obtains the second data as data obtained by making the writing access of the second transaction with respect to a state after the writing access was made with respect to a copy of the hierarchical data for the first transaction, and then making the reading access with respect to a state of the hierarchical data after the writing access of the second transaction.

16. The concurrency control method of claim 8, further comprising:
making the writing access with respect to a shared copy produced by copying the hierarchical data in order to reflect writing accesses made by all transactions that make accesses to the hierarchical data, when the first transaction is to make the writing access with respect to a copy of the hierarchical data; and
storing states of the shared copy at timings at which the writing accesses were made by some of the transactions that make accesses to the hierarchical data;
wherein the judging step obtains the second data as data obtained by reproducing a state of the hierarchical data at a timing at which the reading access is to be made by selecting one of stored states of the shared copy which is close to the state of the hierarchical data at a timing at which the reading access is to be made, making the writing access that was made by the first transaction after that timing, with respect to a selected state of the shared copy, and making the writing access that was made by the second transaction according to need, and then making the reading access with respect to a reproduced state of the hierarchical data.

17. The concurrency control method of claim 16, wherein when there is an upper limit to a number of shared copies that can be recorded, those shared copies which have a higher possibility of being utilized at a time of reproducing a state in which the reading access is to be made later on are recorded at a higher priority, among the shared copies corresponding to states at times of the writing accesses with respect to the hierarchical data.

18. The concurrency control method of claim 1, wherein when the judging step judges that the collision will occur, the carrying out step carries out the processing for keeping those transactions that are determined according to prescribed criteria among transactions related to the collision, to wait until other transactions related to the collision are finished.

19. A transaction processing system for processing a plurality of transactions in parallel with respect to hierarchical data, comprising:
a copying unit configured to produce a copy of the hierarchical data at a time of starting an access to the hierarchical data by each transaction;
a judging unit configured to judge whether a collision between one of reading access or writing access to be made by a first transaction with respect to a copy of the hierarchical data for the first transaction and another one of reading access or writing access made by the second transaction with respect to a copy of the hierarchical data for the second transaction will occur or not;
a processing unit configured to carry out a processing for avoiding the collision when the judging unit judges that the collision will occur; and
a reflecting unit configured to reflect a writing access made by the first transaction with respect to a copy of the hierarchical data for the first transaction, on the hierarchical data, when the first transaction is to be finished normally, and reflect the writing access also on a copy of the hierarchical data for the second transaction if the second transaction is not finished yet.

20. A computer program product for causing a computer to function as a transaction processing system for processing a plurality of transactions in parallel with respect to hierarchical data, the computer program product comprising:
a first computer program code for causing the computer to produce a copy of the hierarchical data at a time of starting an access to the hierarchical data by each transaction;
a second computer program code for causing the computer to judge whether a collision between one of reading access or writing access to be made by a first transaction with respect to a copy of the hierarchical data for the first transaction and another one of reading access or writing access made by the second transaction with respect to a copy of the hierarchical data for the second transaction will occur or not;
a third computer program code for causing the computer to carry out a processing for avoiding the collision when the second computer program code judges that the collision will occur; and
a fourth computer program code for causing the computer to reflect a writing access made by the first transaction with respect to a copy of the hierarchical data for the first transaction, on the hierarchical data, when the first transaction is to be finished normally, and reflect the writing access also on a copy of the hierarchical data for the second transaction if the second transaction is not finished yet.
